(19) United States
(12) Patent Application Publication
(10) Pub. No.: US 2007/0272793 A1
(43) Pub. Date: Nov. 29, 2007

(54) SET OF CONJUGATED COMPONENTS TO BUILD A ULTRALIGHT TYPE AIRPLANE

(76) Inventor: Fernando de Arruda Botelho, Sao Paulo (BR)

Correspondence Address: STITES & HARBISON PLLC, 1199 NORTH FAIRFAX STREET, SUITE 900, ALEXANDRIA, VA, 22314, US

(21) Appl. No.: 11/531,086

(22) Filed: Sep. 12, 2006

(30) Foreign Application Priority Data
May 26, 2006 (BR) 0.603.276-1

(51) Int. Cl. B64C 31/02

(52) U.S. Cl. 244/16

(57) ABSTRACT

A The set of conjugated components to build a ultralight type airplane, in particular a constructive concept that has as end product a ultralight type airplane with a general configuration visually similar to the DEMOISELLE. In summary, the inventive concept has as purpose to enable that a handcrafted and ancient concept airplane is mass-produced, using modern resources, which characterizes by a better aerodynamical sustentation, in particular as a result of parts which are specially designed to carry out the known functions with extraordinarily improved results. In a general concept, without detailing the components in their specific constructions, we define the airplane obtained based on the conjugated components such as the fuselage (1); wings (2); empennages (3); landing gear (4); systems (5) which include the control (6) with rotular ends and fuel systems consisting of a metallic tank (7) fixed on the same level of the engine, with a vent, cover and a system cutting valve and propelling unit (8).

### BACKGROUND OF THE INVENTION

1. Field of the Invention

The present Invention Patent application discusses the set of conjugated components to build a ultralight type airplane, in particular of a constructive conception that has as end product a ultralight type airplane, with general configuration visually similar to the Demoiselle version created by Santos Dumont. In summary, the invention concept has as purpose to enable that handcrafted and ancient concept of an airplane to be mass-produced, based on modern resources, so that, among all characteristics, the invention characterizes by an improved aerodynamical support, in particular as a function of the parts especially designed to carry out known functions with extraordinarily improved results; therefore, the purpose of the present patent is precisely this set of parts to build a ultralight type of airplane of the above referred kind.

2. Description of the Prior Art

Everybody knows that airplanes went through a quick development immediately after the first of a flight heavier than air, that is to say the 14 Bis, until it reached the modern airplanes, which currently cross the oceans, safely and comfortably for their passengers. In general terms, airplanes, or why is it that something heavier than air can fly, is a conceptual issue that in the case of the fixed wing airplane is explained by the difference of pressure on the lower and upper sides of the wings, where the airfoil profile allows that this pressure difference is determinant so that, under speed the airplane is raised and supported by this above referred pressure difference.

So, starting from the first airplanes, it is undeniable that a quick and extraordinary evolution has taken place since the first plane and up to the ones we know currently.

This is the history of aviation. It is a fact also that airplanes has always drawn, draw now and will continue to draw in the future, great attention from people, because the feeling of flying is indescribable.

At the beginning of this fantastic history we had airplanes built with bamboos improvisedly tied up, with rudimentary connection parts. However, the “concept” used in the first aircraft heavier than the air (which provenly flew) is still up-to-date and was the base for extraordinary advances in the air field.

And this beautiful story goes through several stages, from the slow airplanes which flew at low altitudes and up to the most modern ones which cross the 900 km/h barrier and cruise at an altitude of 12,000 meters. The airplanes which originally were not pressurized, have long been pressurized, thus allowing for higher flights, at higher speeds, with increased comfort both for passengers and crew.

The airplanes not only evolved from the structural elements of view, such as fuselage, wings, tails and other elements, but also as regards the means employed for their propulsion, which went through different steps, from the two-blade propeller and up to the more developed propellers, which later were associated to the turbo system and then to the pure turbo system.

Finally, the challenge was always to fly quicker, higher, safer and with increased comfort.

Nowadays, the great majority of commercial aircraft used for transportation of passengers, include a pressurized fuselage, a wing placed approximatedly on the middle of said fuselage and a tail behind the wing, besides the propellers. In summary, this is the actual concept of commercial aircraft.

However, throughout this period of advance of the technology for the construction of airplanes, many aspects have been modified step by step, not only in constructive and structural terms, but also as regards the materials used in the manufacture, with the composite materials, being today used on a large scale.

Within this philosophy, and returning to the beginnings of aviation, it we see that the first airplanes were manufactured with rudimentary materials, if compared with current technology, but they were those available at that time. Initially, materials such as wood and bamboo have been used to build the fuselage, ropes of piano used as cables, silk fabrics on the wings, and other improvised materials, that motivate mainly Santos Dumont.

The fact is that, starting from the first airplanes which really flew, such as the Demoiselle, the evolution brought fast technological progress which nowadays all of us are aware of. Obviously, the concept used in the first models that flew were pertinent, that is why they flew. Among the reasons for the success of these airplanes, besides an important and well-founded conceptual aspect, the materials which although rudimentary and improvised had low weight.

The airplanes with constructive characteristics similar to the demoiselle, many times were built with modern materials, but they could not fly, because, for the operational success of the airplane, which is a type of ultralight, it is not enough jut to update the materials, but also the structural components, in particular the wings, with the purpose of providing a better sustentation, enabling the plane to fly higher and very safely.

The present invention is based on this principle is, that is to say, it introduces a novel proposal of a set of components to build of an ultralight plane, with characteristics similar to the models from the early times of aviation, made however of modern materials, adding important improvements, specially in the structural level, particularly in the wings, as well as in the commands, connections between parts, among others that will be perfectly detailed during this description.

The present invention, in general, has as subject a set of components to build an ultralight plane that keeps some similarities in the general configuration with the Demoiselle model of the early times of aviation; however, it is identified by parts specially developed to attend the modern construction of aeronautics, extraordinarily improving the plane sustentation and gliding compared to its original concept; that is to say, the specially created components allow us to have a plane which is not an exact reproduction of the Demoiselle model of Santos Dumont, which manages to fly indeed with excellent sustentations, even when manufactured with modern materials, having easy-to-handle commands available to the pilot who sits in a safe cell; the several devices such as ailerons (new in this kind of airplane), are also operated by special means which render the set highly effective and quick in its answers.

Explained in more detail, the present invention stands out, preliminarily, because of the profile of the wings, which basically consists of two profiles, the first substantially in the form of a “T” and the second substantially in the form of a “V”, united between them by means of rivet or similar type devices. The airfoil profile adopted with this ultralight, similar to the Demoiselle, has more section or height than the original, the section determined precisely by the concept of the above referred profile, specially intended for this application.

Actually, the profile of the wings created for this airplane intends to solve the greatest problem of the initial version, that is to say, its sustentation. We must consider that, within the universe of wing profiles, each profile is designed always in order to meet an increased need, such as speed, weight, performance, etc. In this case, the inventor designed a profile for sustentation purposes.

One characteristic also sought after by the inventor, in the sense of eliminating unfavorable factors in the initial Demoiselle version, has close relation with the discomfort of the pilot as well as the commands. In the original version, a control wheel was used, which turned and inclined the aircraft, and which drove both the rudder and the elevator. So, when the inventor replaced these commands by a joystick and conventional flying pedals, he needed to design also new means and devices, so that a craftmanlike airplane could be mass-produced and that the commands reacted effectively and quickly, offering safety and comfort to the pilot. For that purpose, important devices were created which shall be described throughout this report.

Among these components we can mention steel cables going through plastic pulleys, with special stretchers made, preferably, of stainless steel; besides, novel aileron commands which are new in this kind of ultralight airplane.

With the commands above referred, the invention allows, further, an increase of the elevator course; while the stretches have a novel construction using rods preferably made of stainless steel with threads at the adjustment ends.

Another feature of this ultralight type airplane construction, still as regards the new set of parts, concerns the fuselage, built of a tubular structure, with aluminum tubes of aeronautical alloy, for instance, aluminum 6061 T6, with some steel reinforcements, preferably steel 4130N, but which are not obligatory. The sheer stresses of the back truss are absorbed by diagonal wires made of steel with tension adjustment threads on the ends. The aluminum tubes are interconnected through stainless steel or age-hardening aluminum “blind” rivets; they are redundant as structural safety device.

The above referred steel tube reinforcements are interconnected through TIG type welding, with mild steel (low carbon content and alloy elements) added material. In some points of the tubular structure, there are AN type screws as connection elements.

The structure, as it was the case of the original version of the airplane, has no coating, and thus it is exposed to the airflow.

The wings are on the top, with no flaps, built with two tubular girders, preferably made of aeronautical alloy aluminum (type 6061 T6), with three series of support. The first series of support is formed by steel tubes which connect the lower part of the fuselage to the girders; the second and third series of supports are built of steel cables, which connect the girder to the lower part of the fuselage, and the girder to two compression tubes (“King post”), one of them aligned with the back girder and the other with the front girder.

The above described sequence of wires and tubular support generate a redundant structure, which supports the positive and negative loading of the wing, and also supports the wing torsional stresses. Therefore, the tubular girder is submitted to flexion-compression stresses. The tubular girders are interconnected by a series of aeronautical alloy aluminum (type 6351 T6) type “T” profile ribs, connected through multiple aluminum rivets thus generating the shape of an airfoil and the support and compression structure among the girders.

The leading edge is made of an aeronautical alloy aluminum (type 6061 T6), which is interrupted in order to allow for the movement of the propeller. The trailing edge is made of aeronautical alloy aluminum plate (type 5053 H34) and fixed with the rivets on the ribs. The wing is coated with glued polyester fabric, shrink-wrapped and sealed, with no UV ray protection.

The empennages are built of aeronautical alloy aluminum (type 6061 T6) pipes of reduced diameter, interconnected by means of riveted. The empennage is coated with glued polyester fabric, shrink-wrapped and sealed, and as in the case of the wings has no UV ray protection.

The empennages are fully mobile and rigidly connected through steel cables; all the set has horizontal and vertical pivot movement on steel and aluminum bearings. The pivoting of the set is driven through steel cables connected to the airplane control system. Because of the possible aerodynamical excitement of the wing on the empennage, the whole set is 100% balanced on the vertical and horizontal axes.

The landing gear is of the conventional type with rayed wheels on the front and a small wheel fixed on the tail cone. The main landing gear axis is preferably made of Cr—Mo (chromium-molybdenum) steel 4130 connected to a tube preferably made of Cr—Mo steel 4130 with large diameter that connects the wheels and which is welded with the remaining airplane structure. The tires are of the kind used in bicycles, with inner tube, and the wheels have mechanical disk brakes (bicycle brakes).

The control system is made through steel cables, with rotular ends. The fuel system consists of a metallic tank fixed at the same level as the engine, with vent, cover and a system cutting valve. The airplane has no electric, electronic or hydraulic system.

As regards the driving force, the airplane uses Otto's, four-cycle engine, fueled by airplane gasoline and started through CDI with cutting switch available to the pilot and has preferably a power of 68 HP and is also preferably cooled with water and oil.

The engine cradle is made of 4130N steel tubes preferably welded and bound to the structure through rubber pads. Further, in order to adapt this ultralight type airplane to good sustentation and airworthiness conditions, the inventor, in his research, eventually increased the span 1-1.5 m, while the chord and the tail keep the already known dimensional ratios.

As regards the instruments, the airplane has speedometer, tachometer and hour meter.

### SUMMARY OF THE INVENTION

One first purpose of the invention is to propose a set of conjugated components to build a ultralight type airplane, through which it is possible to build ultralight type airplane which is a not identical replication of the Demoiselle airplane of Santos Dumont, capable of being mass-produced quickly and effectively.

A second purpose of the invention is to propose a set of conjugated components to build a ultralight type airplane through which a ultralight type airplane is achieved which has an improved sustentation as compared with the original not only as a function of the materials employed in its construction but also as a function of the specific constructive features of the components employed in it.

And, further, another process of the invention is to propose a set of conjugated components to build a ultralight type airplane, through which an airplane is achieved that, adding the resources of state-of-the-art technology of materials and the aeronautical construction, manages indeed to fly, particularly at a cruise speed around 90 Km/h.

And, also, another purpose of this invention, is to propose set of conjugated components to build a ultralight type airplane through which an innovating wing profile for this kind of airplane is achieved, the construction of which brings about its own solutions and which is the main reason of the excellent sustentation. This wing includes special “T” and “V” shaped profiles.

Another purpose of the invention is to propose a set of conjugated components to build a ultralight type airplane which includes, as an innovation for this kind of airplane, the command of ailerons.

### BRIEF DESCRIPTION OF THE DRAWINGS

FIG. 1: A perspective view of the airplane, showing in particular the positioning of the wires;

FIG. 2: Partial side view of the airplane, without the wires, the engine, the seat and the commands;

FIG. 3: Top view of the airplane of FIG. 2;

FIG. 4: Partial perspective, showing part of the engine and the support elements under the wing;

FIG. 5: Partial perspective showing the bracing device of one of the wheels;

FIG. 6: Partial perspective showing part of the wing and the pilot's seat.

FIG. 7: Partial perspective showing the commands, in particular the joystick and one of the wheels of the landing gear;

FIG. 8: Partial perspective showing in more detail part of the aluminium tubes of the structure and one of the wheels with a stylized representation of the breaking device;

FIG. 9: Partial perspective showing the commands with details of the pedals;

FIG. 10: Partial perspective showing the second set and some structural aspects and the steel cables;

FIG. 11: Partial perspective showing the first set, in particular the driving of the tail wheel and the rudder;

FIG. 12: Enlarged perspective showing the coupling of a joint in the first set;

FIG. 13: Vertical perspective of the tail

FIG. 14: Perspective of the front axes;

FIG. 15: Lower perspective showing the detail of the cable transmission for the aileron;

FIG. 16: Partial perspective showing part of the fuselage and the passing of steel cables through pulleys;

FIG. 17: Perspective showing the detail of the steel cables passing through intermediate pulleys, to the elevator;

FIG. 18: Perspective showing the detail of the steel cables passing through intermediate, pulleys to the tail wheel;

FIG. 19: Partial perspective of the wing showing its structural aspect;

FIG. 20: Perspective showing the wing bushings fixation, to receive the corresponding wires;

FIG. 21: Partial perspective of a wing rib;

FIG. 22: Partial perspective of the wing and part of the junction structure among pipes;

FIG. 23: Perspective showing part of the fuselage and part of the empennage, during assembly;

FIG. 24: Perspective showing in particular the engine support pads;

FIG. 25: Partial perspective of the structural details beside the crosspiece

FIG. 26: Perspective view of the tail connection set;

FIG. 27: Perspective view of catch configuration;

FIG. 28: Perspective view of catch configuration;

FIG. 29: Perspective view of catch configuration;

FIG. 30: Perspective view of catch configuration;

FIG. 31: Perspective view of the front wheel access;

FIG. 32: Perspective view of the horn;

FIG. 33: Perspective view of the middle set plate;

FIG. 34: Perspective view of the wing bushing;

FIG. 35: Perspective view of the wing pipe;

FIG. 36: Perspective view of the brake;

FIG. 37: Perspective view of brake handle;

FIG. 38: Perspective view of airplane structure pipes end;

FIG. 39: Perspective view of the pedal fixation pipe;

FIG. 40: Perspective view of the pedals axes;

FIG. 41: Perspective view of the lower axes;

FIG. 42: Perspective view of the pulley and engine support set axis.

FIG. 43: Perspective view of the engine support catch;

FIG. 44: Perspective view of the special plate;

FIG. 45: Perspective view of the base of the spindle that fixes the wing;

FIG. 46: Perspective view of the steel wire (catch) and nylon used on the wing;

FIG. 47: Perspective view of the wing tube catch;

FIG. 48: Perspective view of the vertical tail fixation skirt;

FIG. 49: Perspective view of the second set;

FIG. 50: Perspective view of the second set lever, and

FIG. 51: Perspective view of the second set catch.

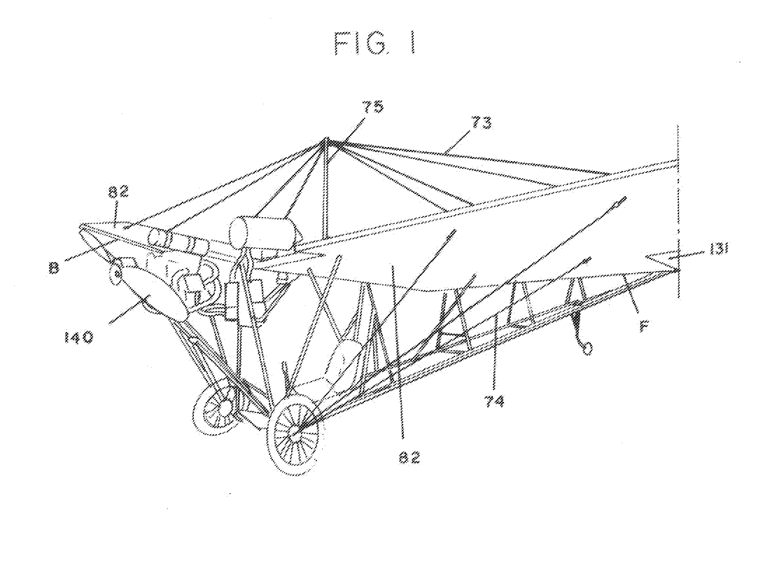

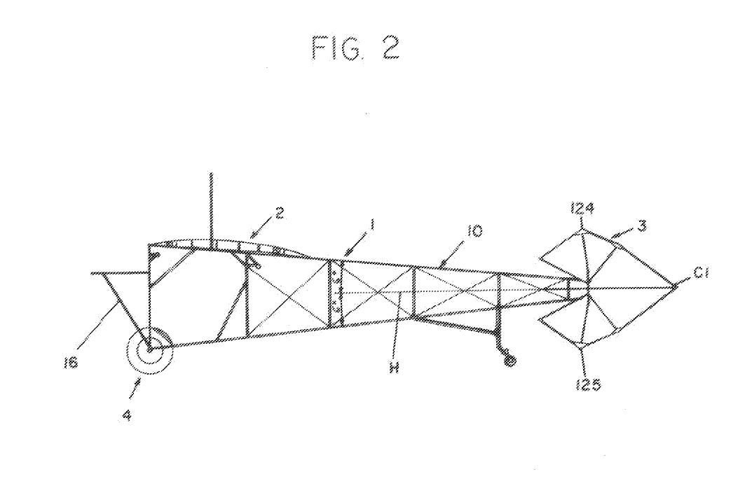

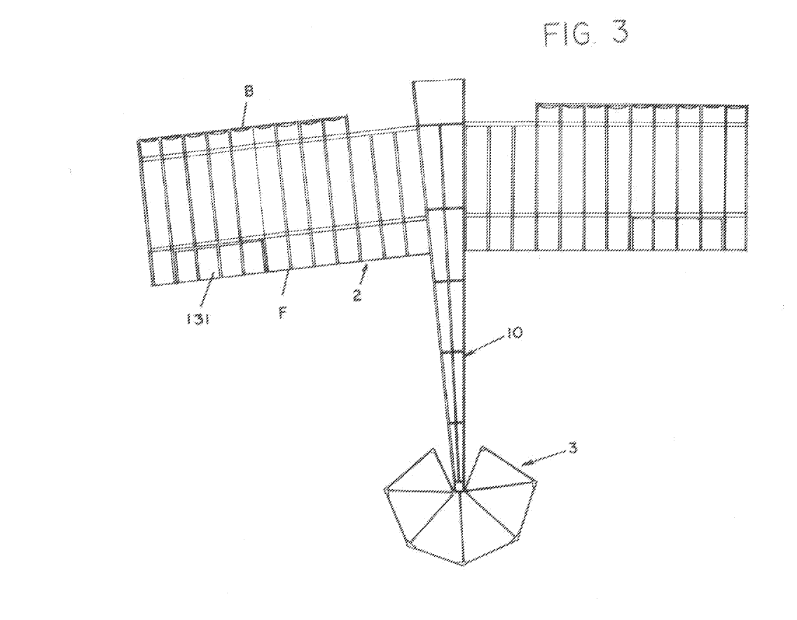

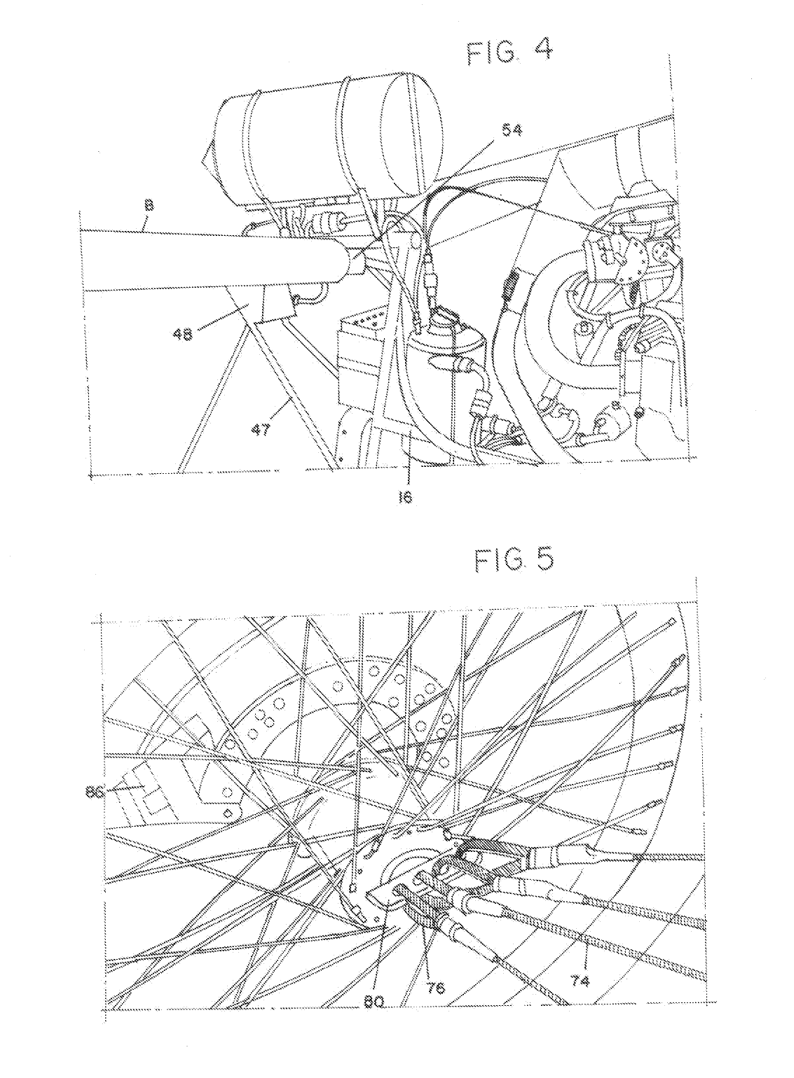

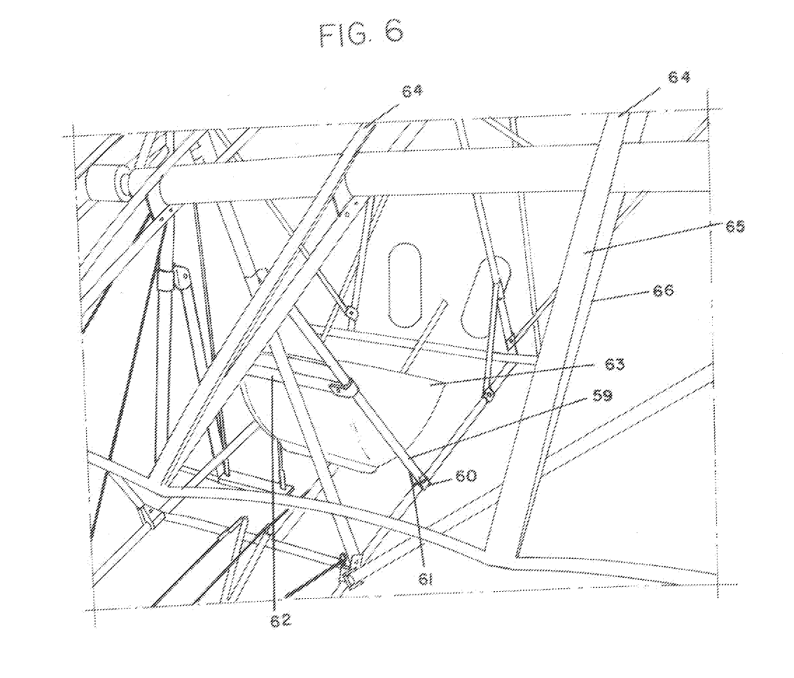

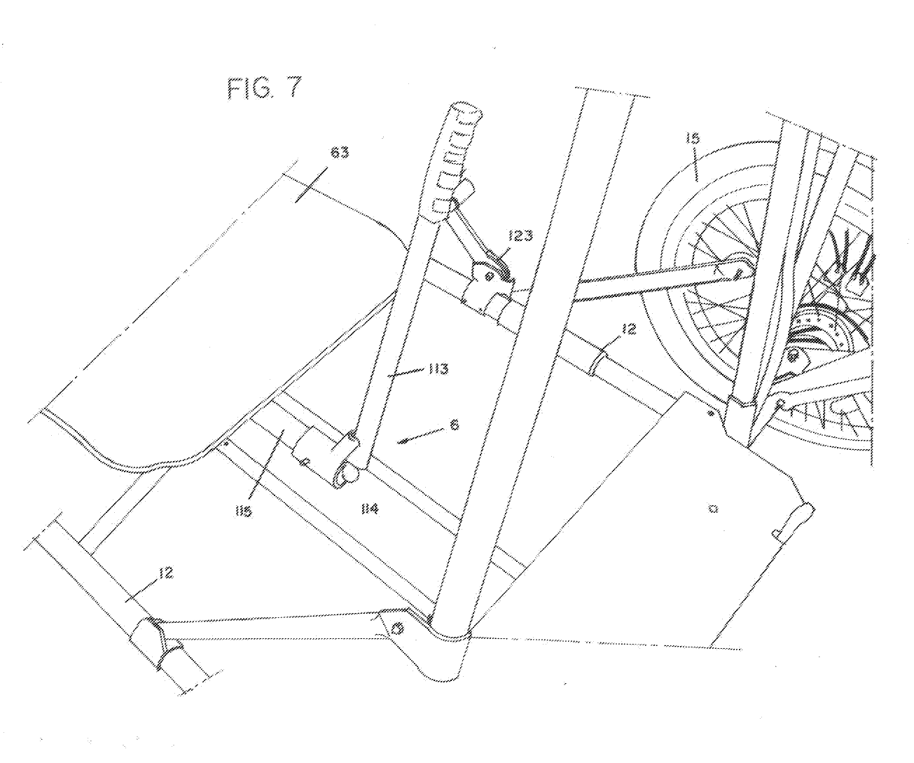

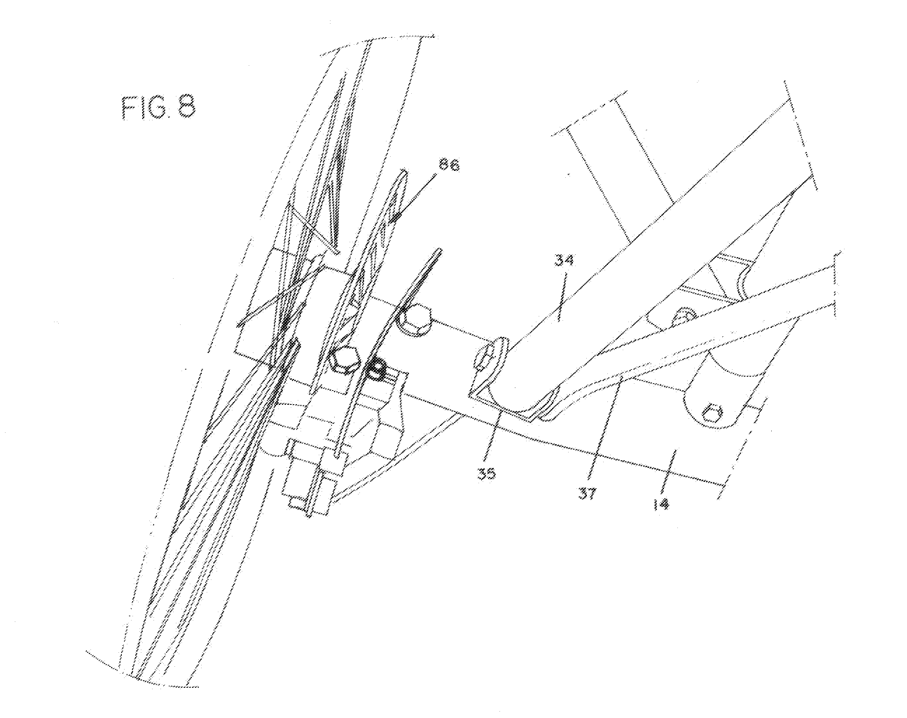

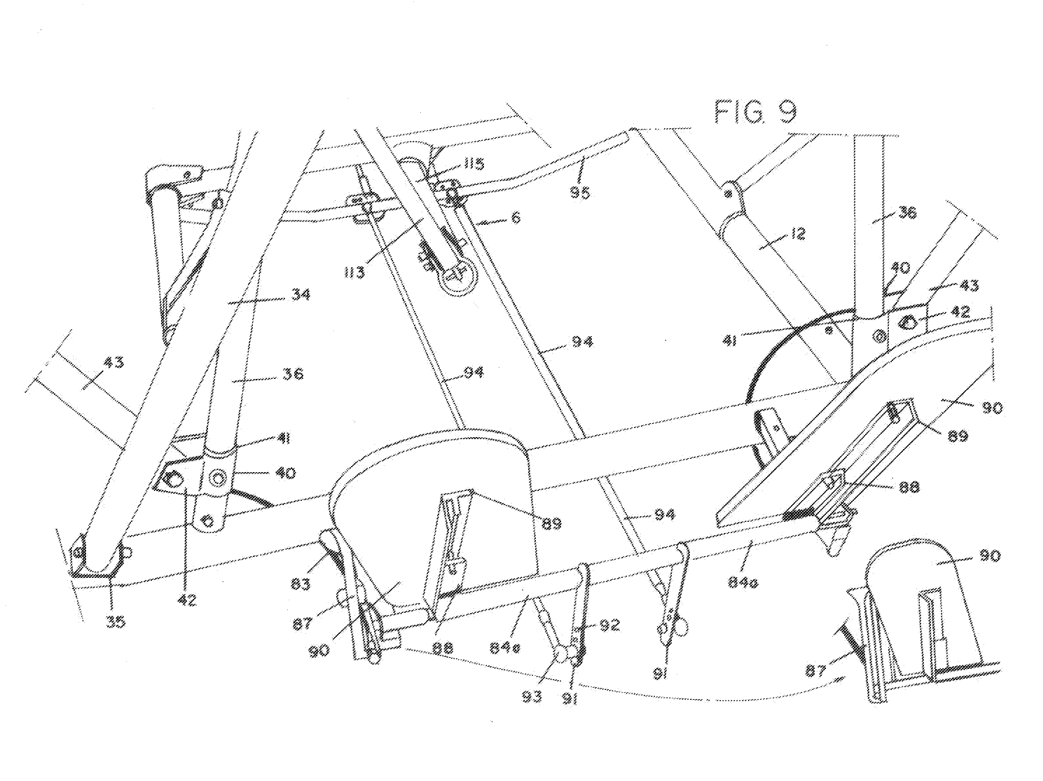

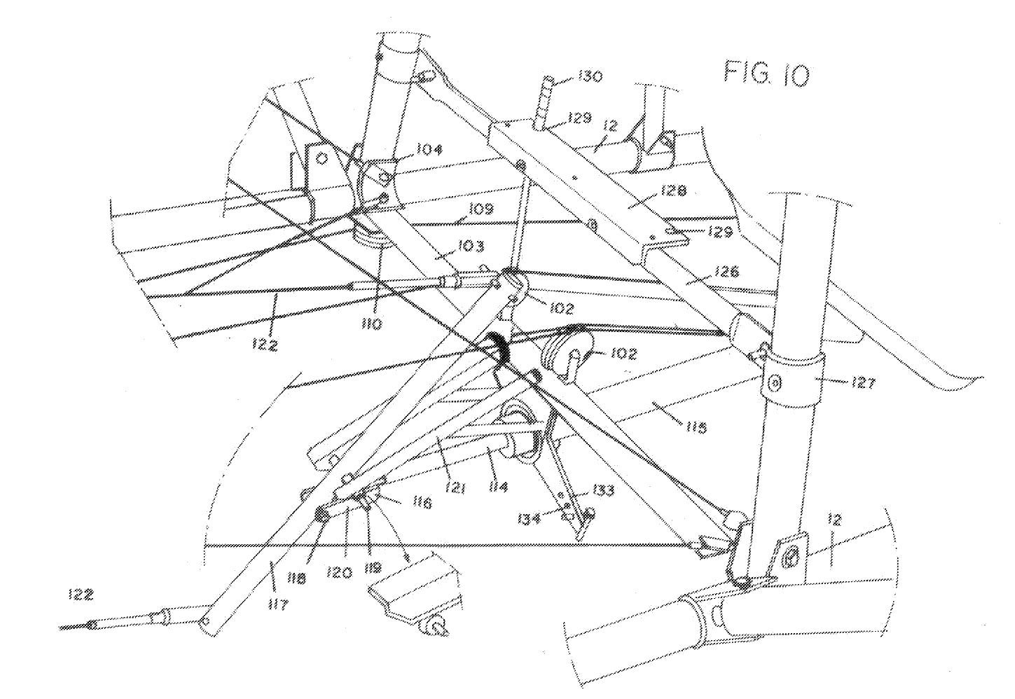

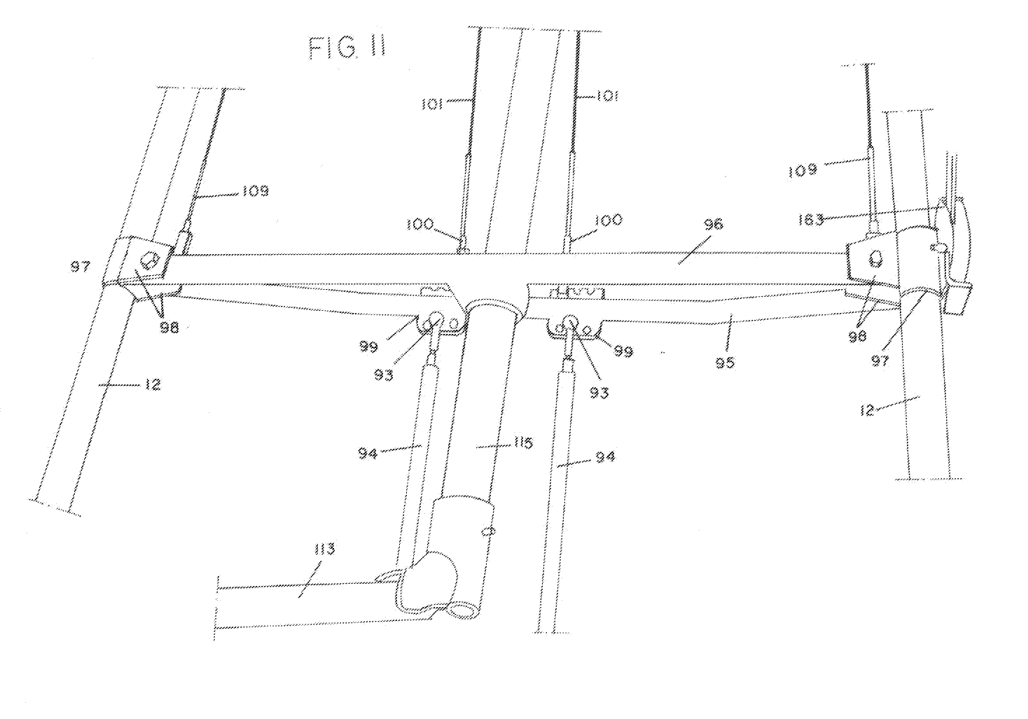

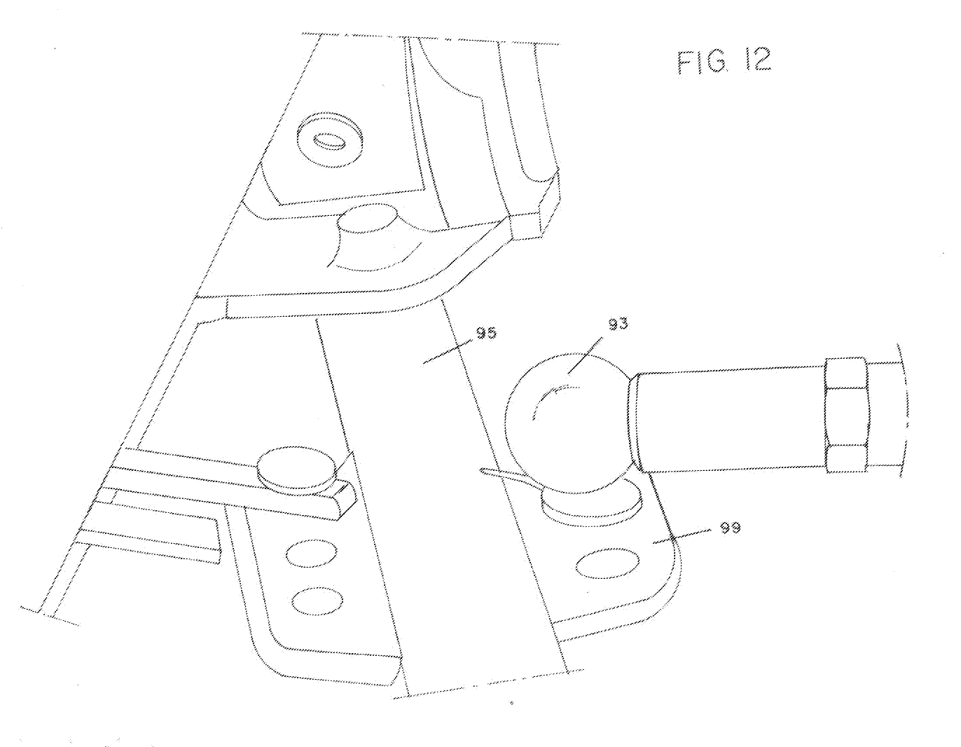

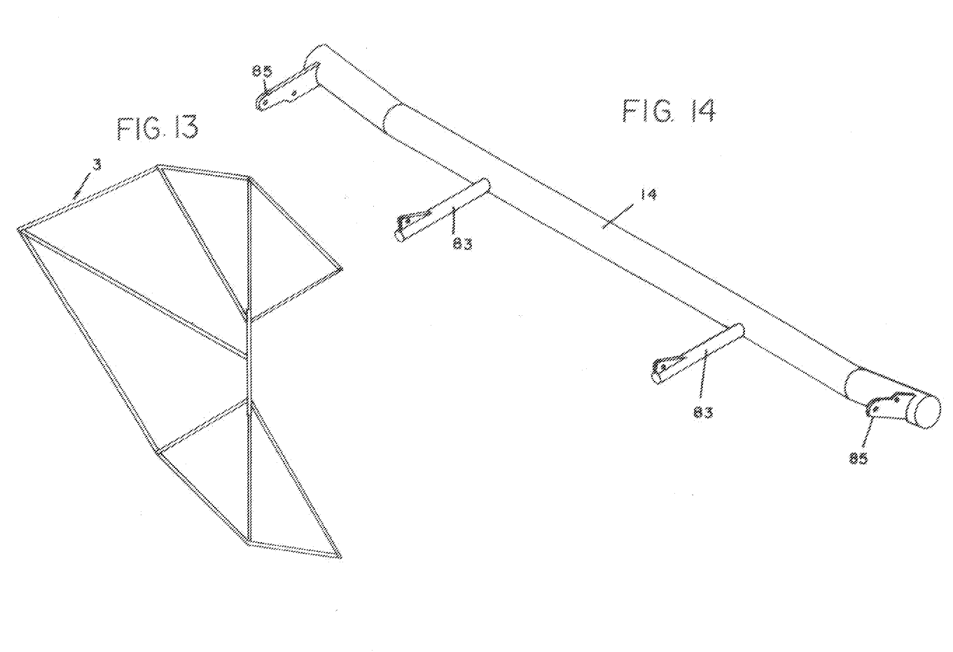

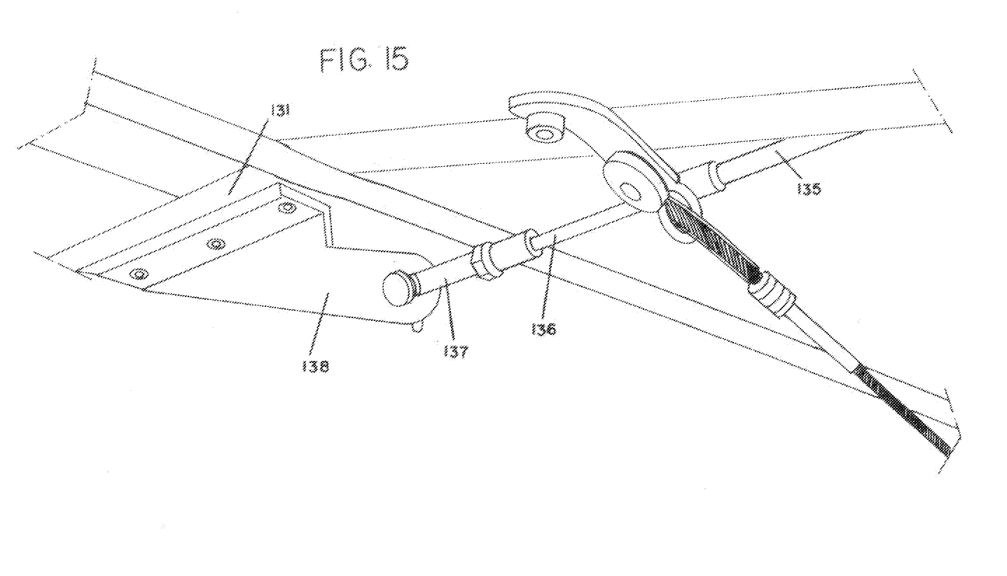

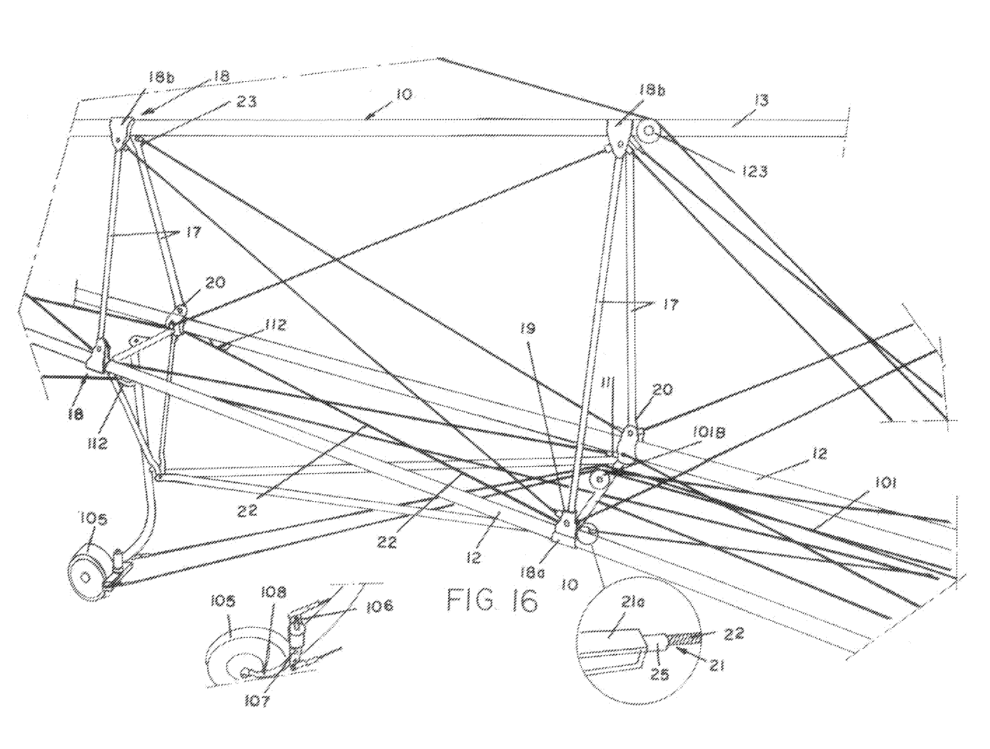

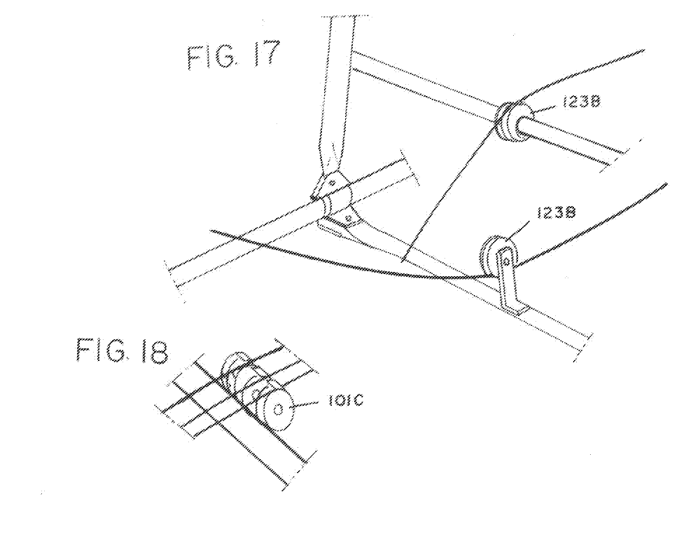

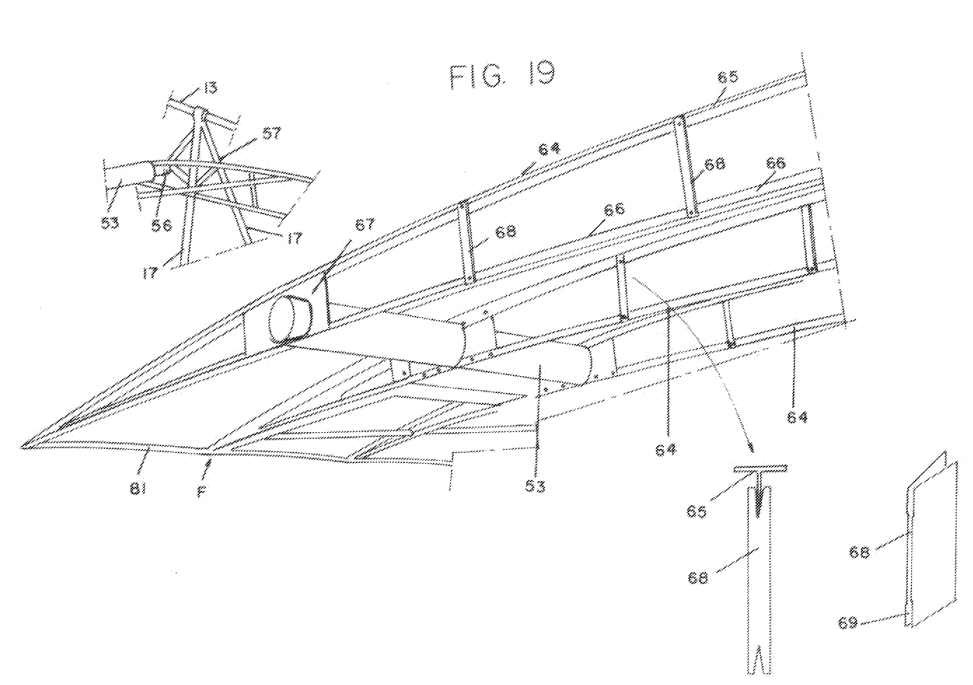

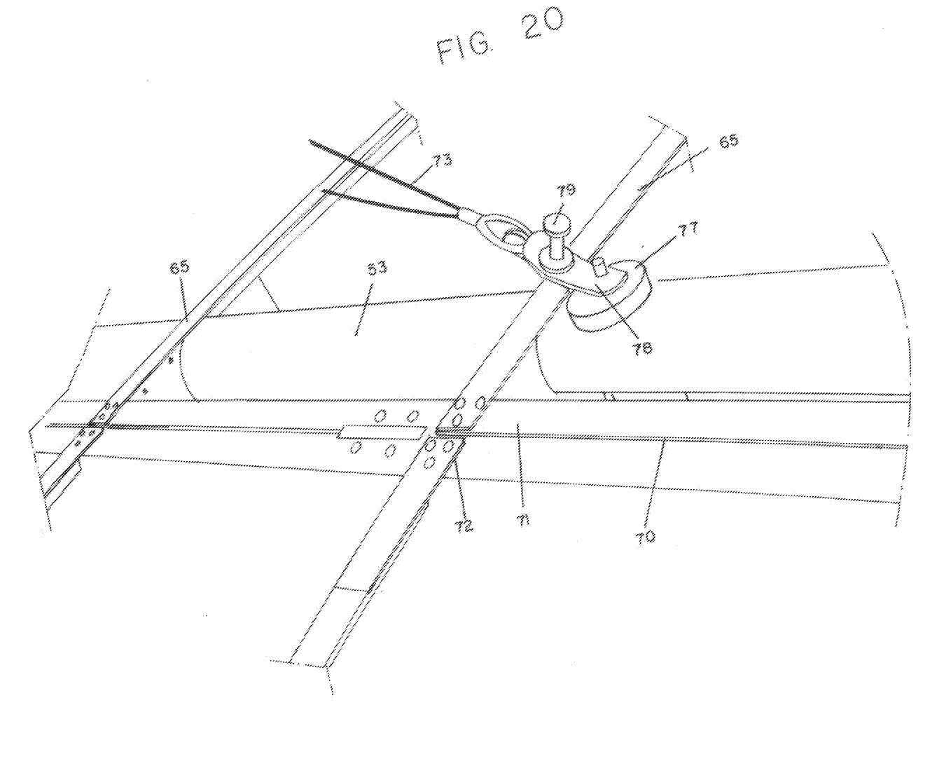

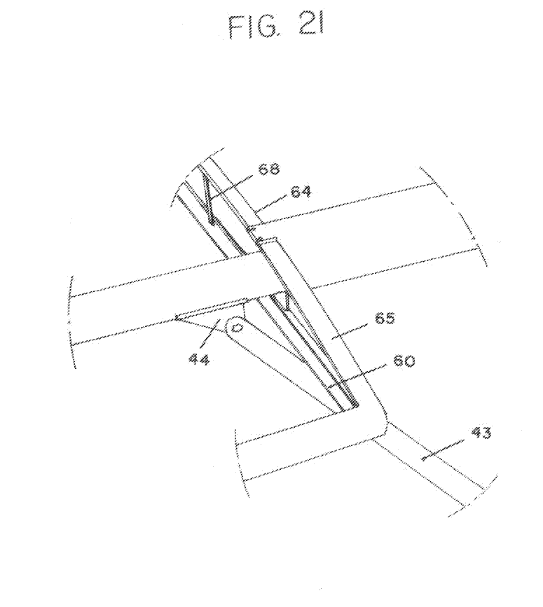

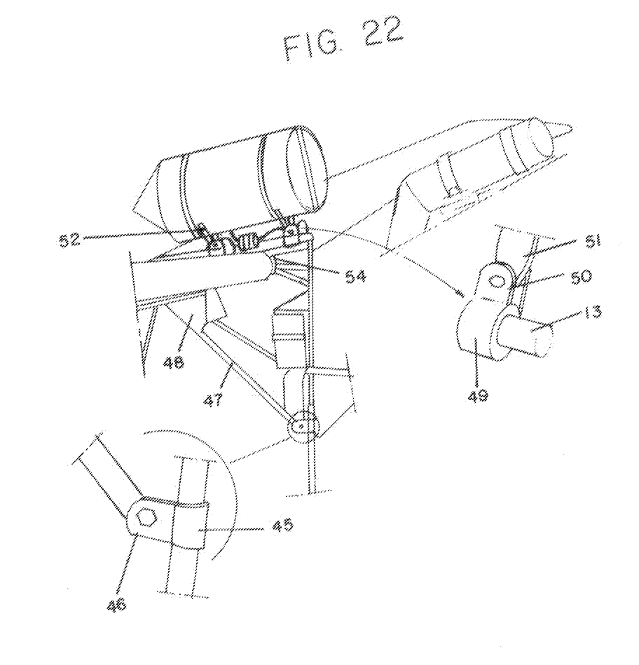

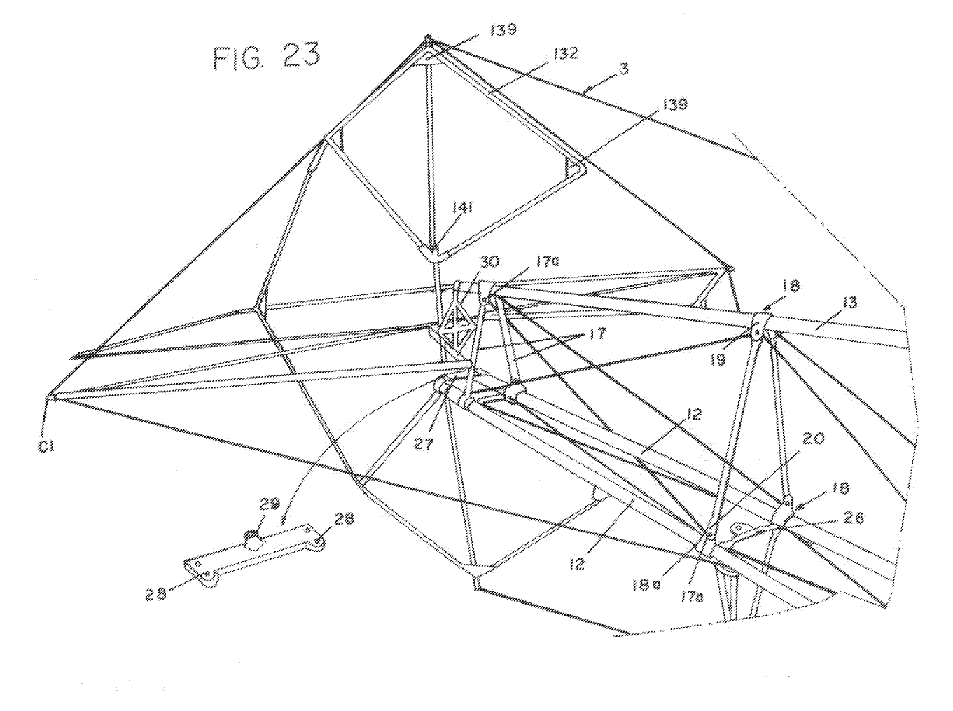

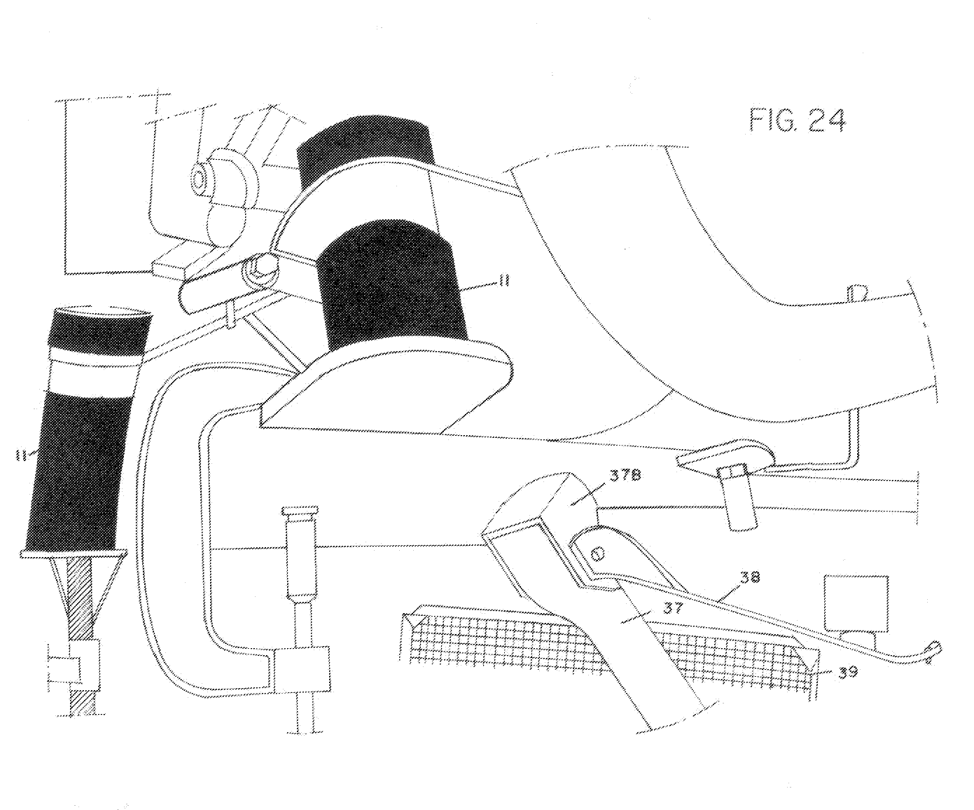

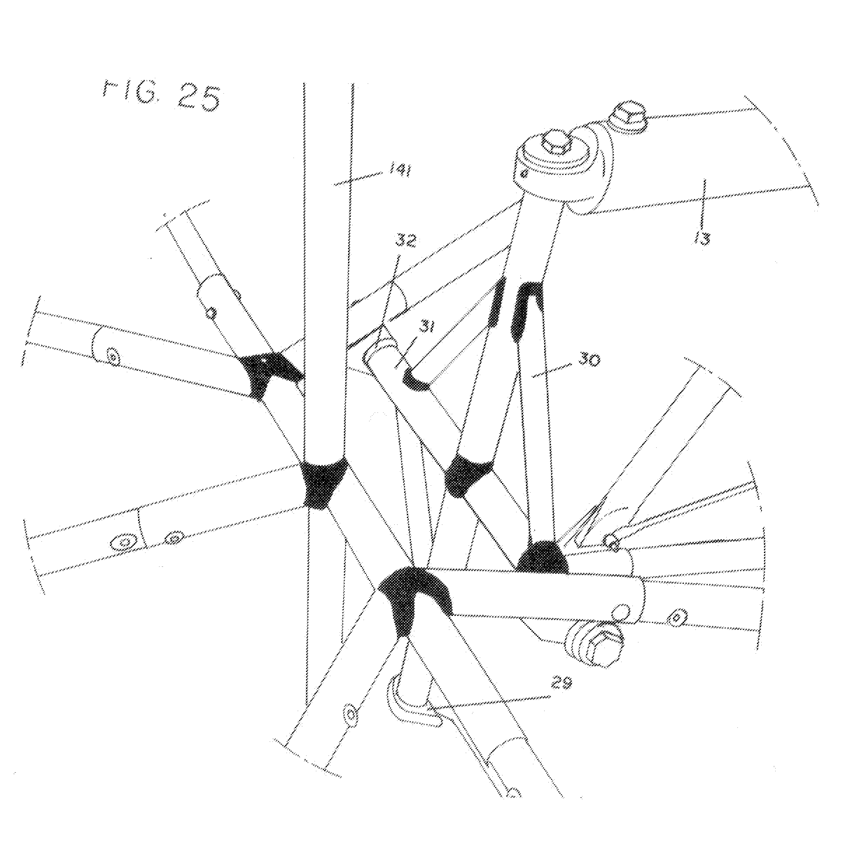

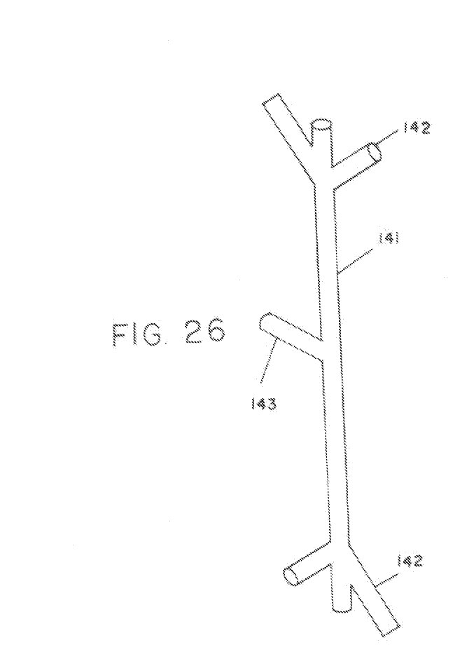

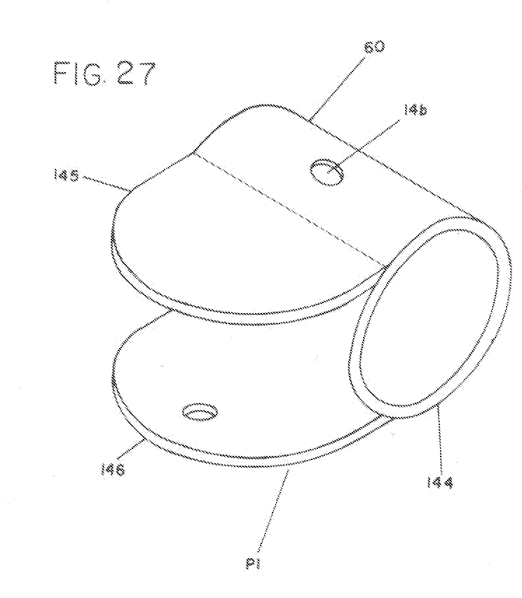

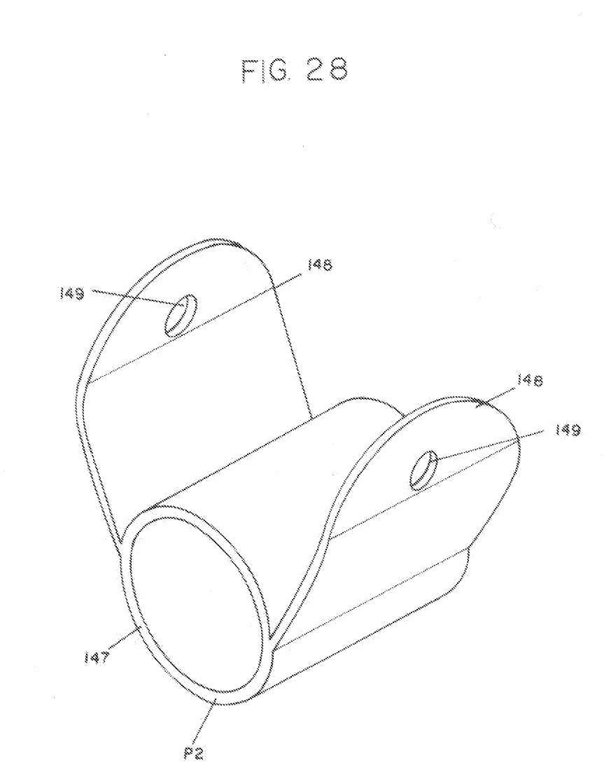

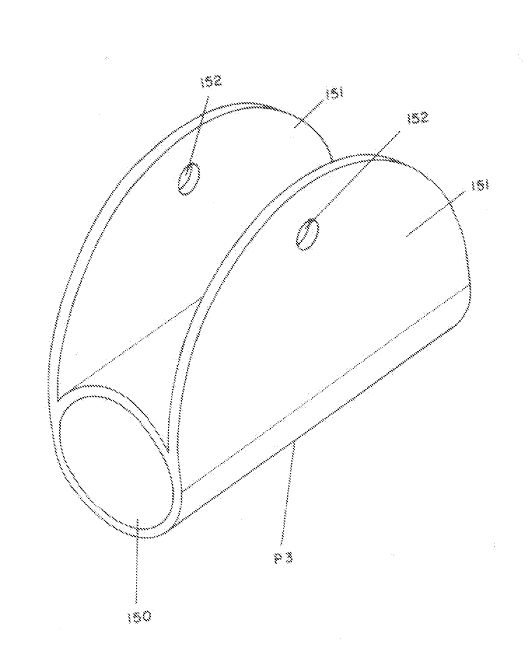

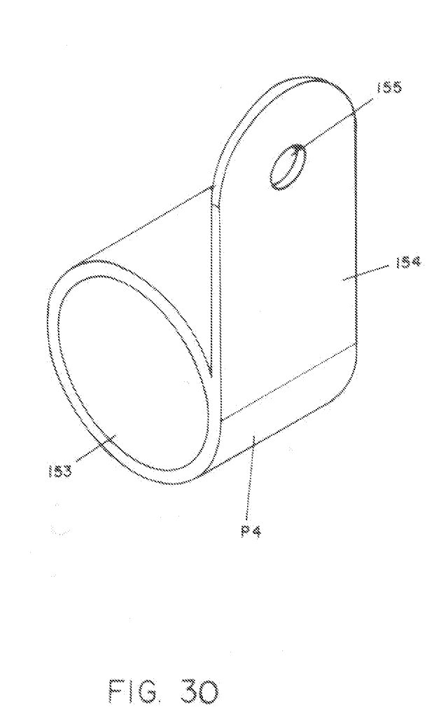

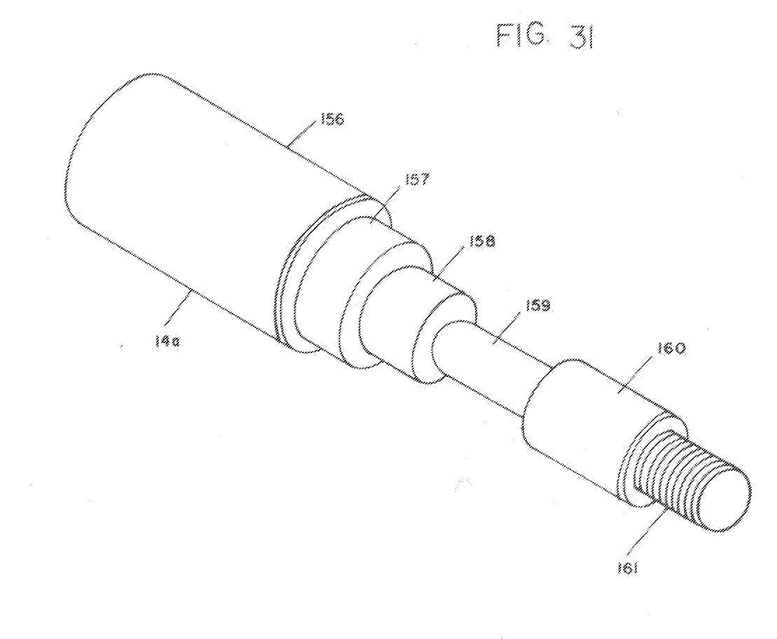

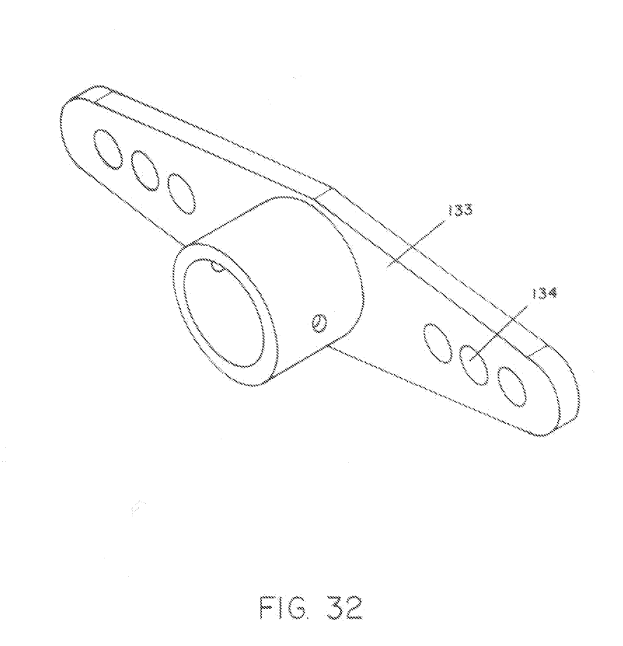

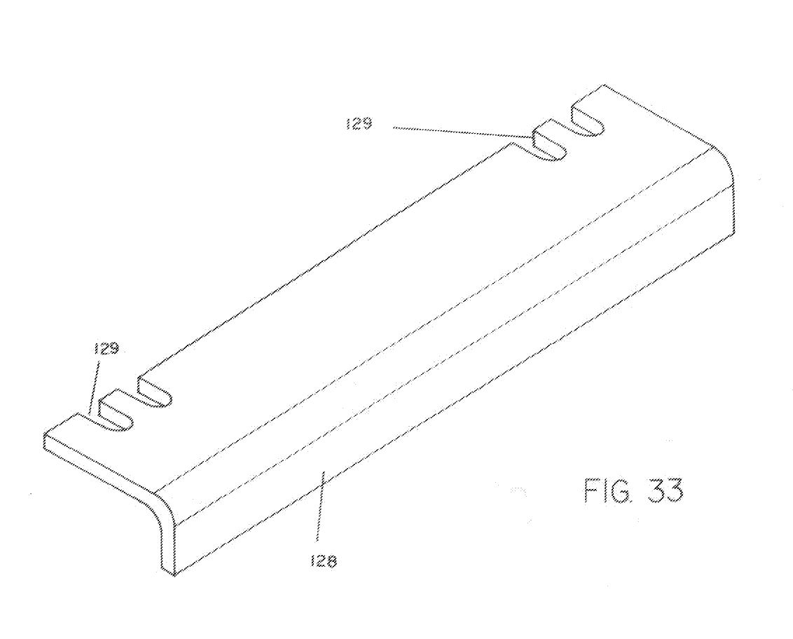

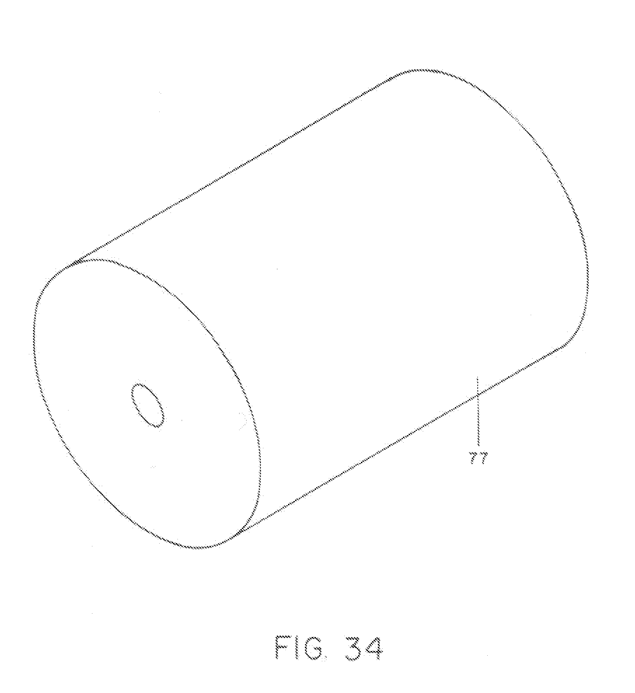

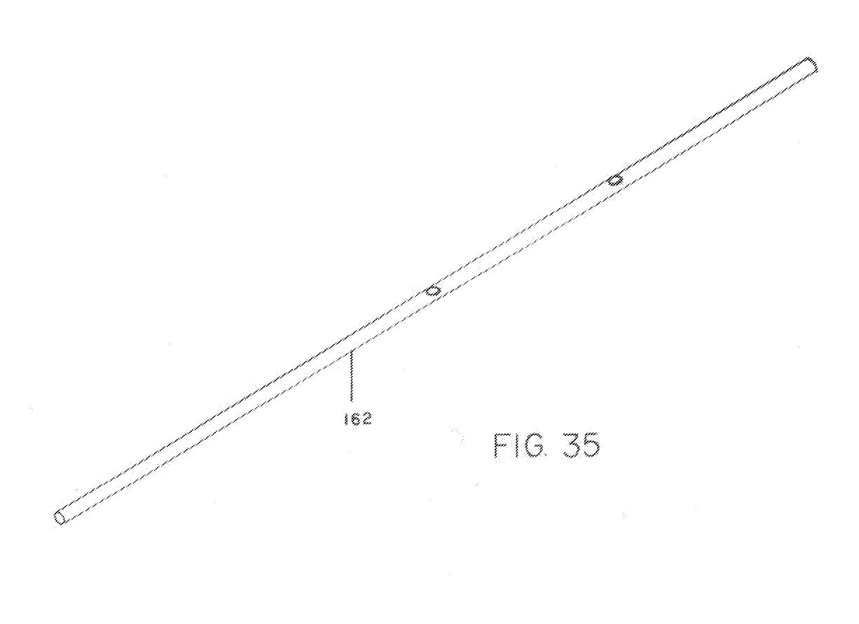

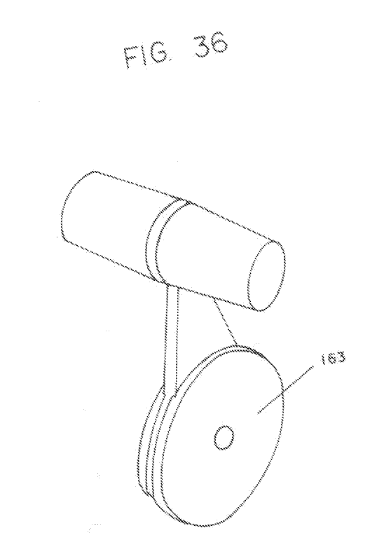

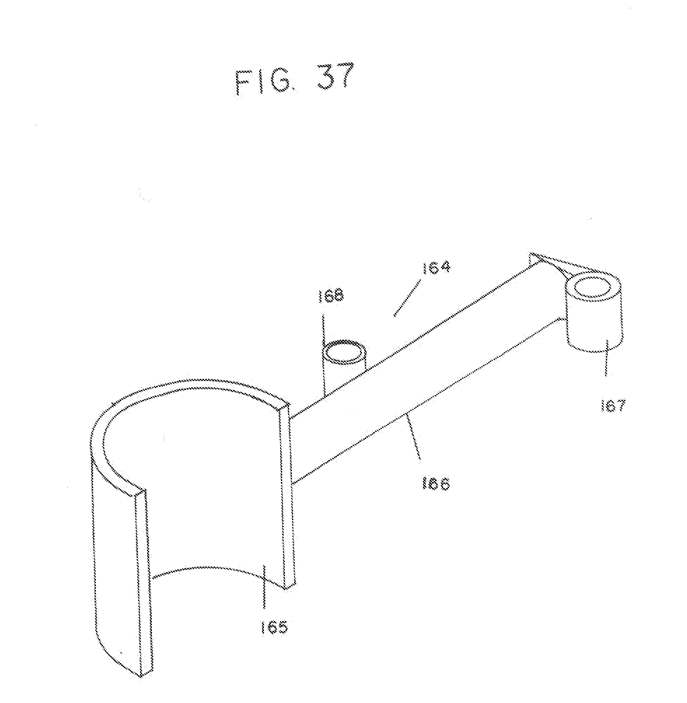

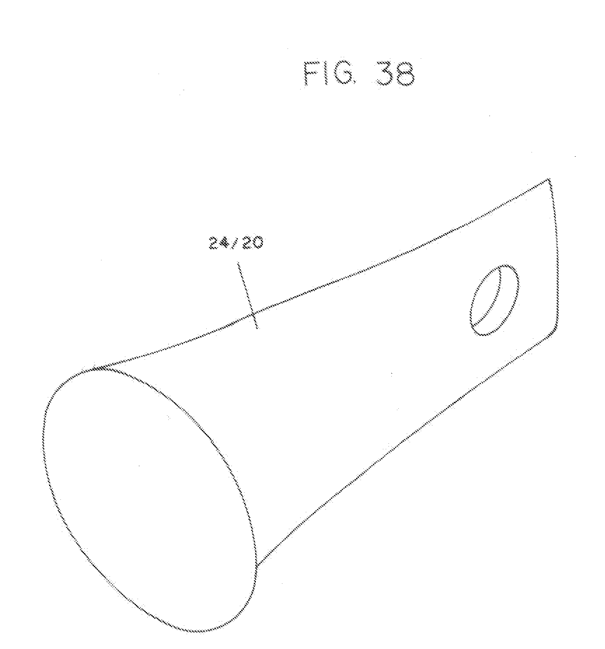

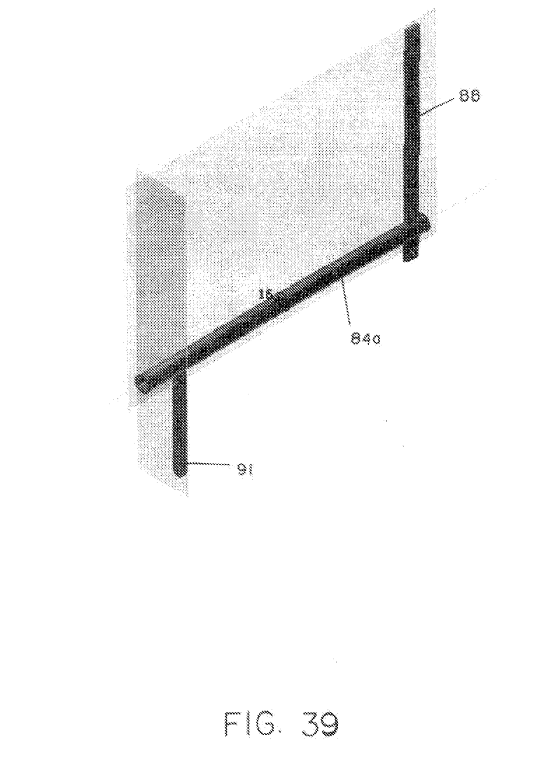

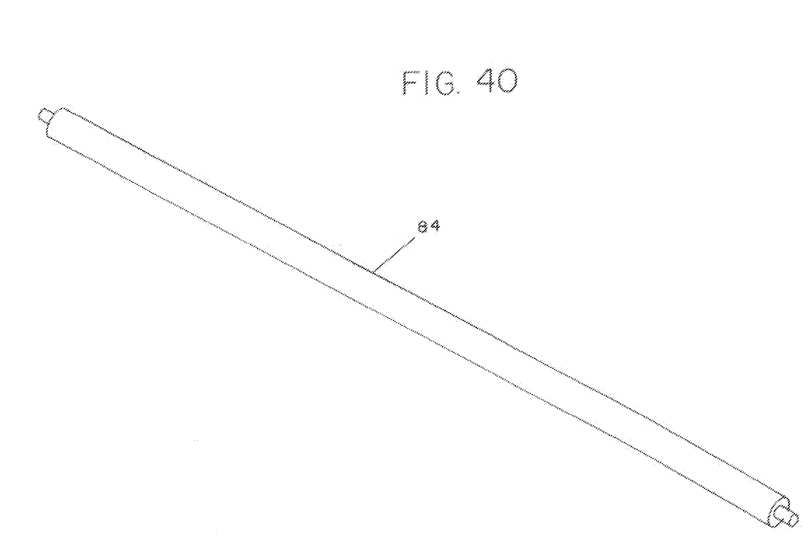

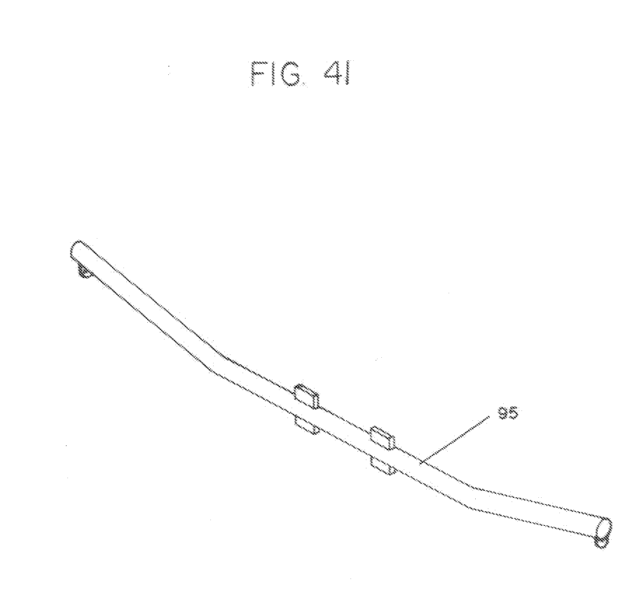

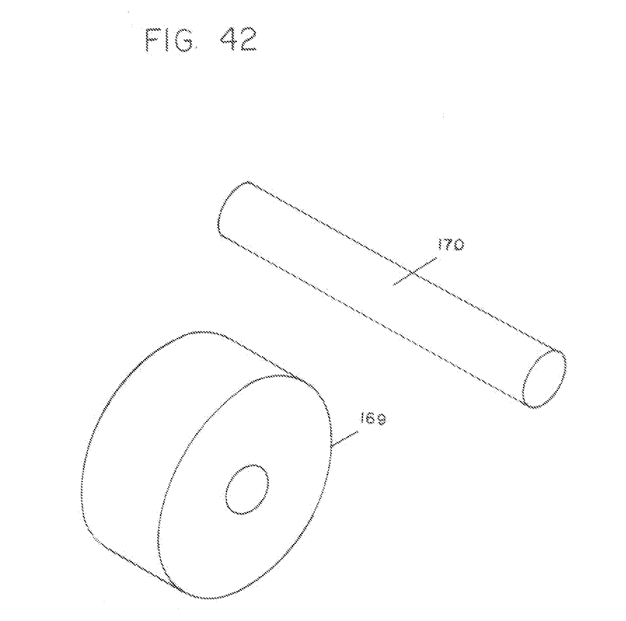

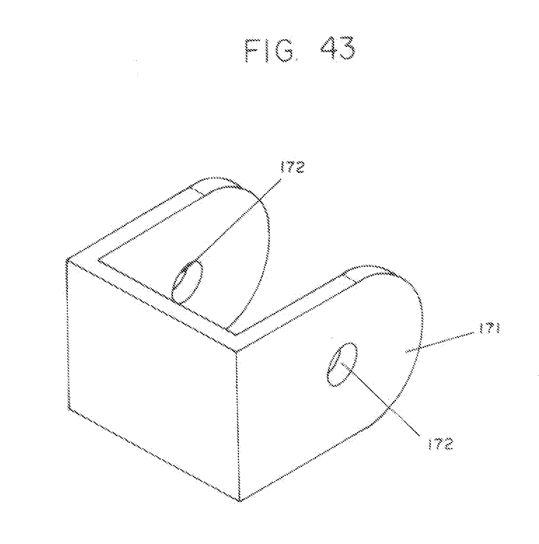

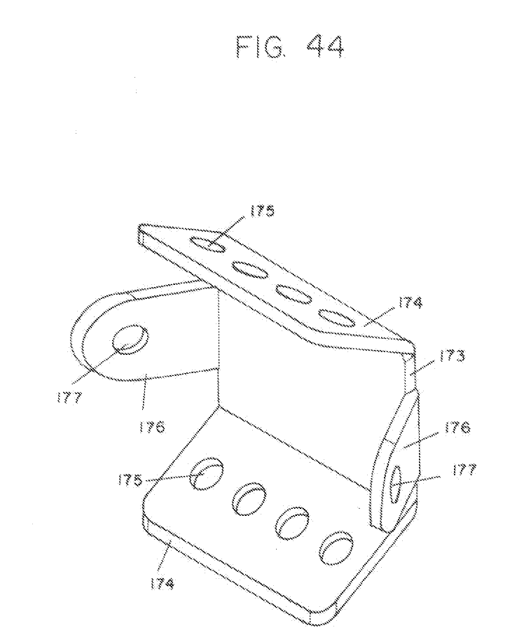

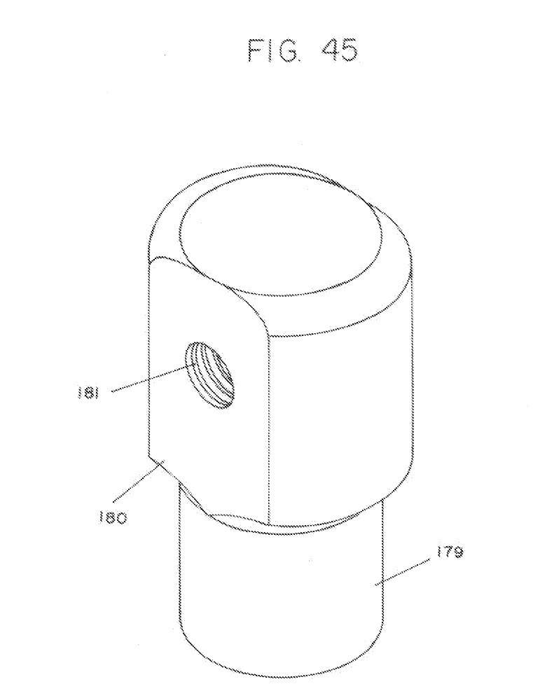

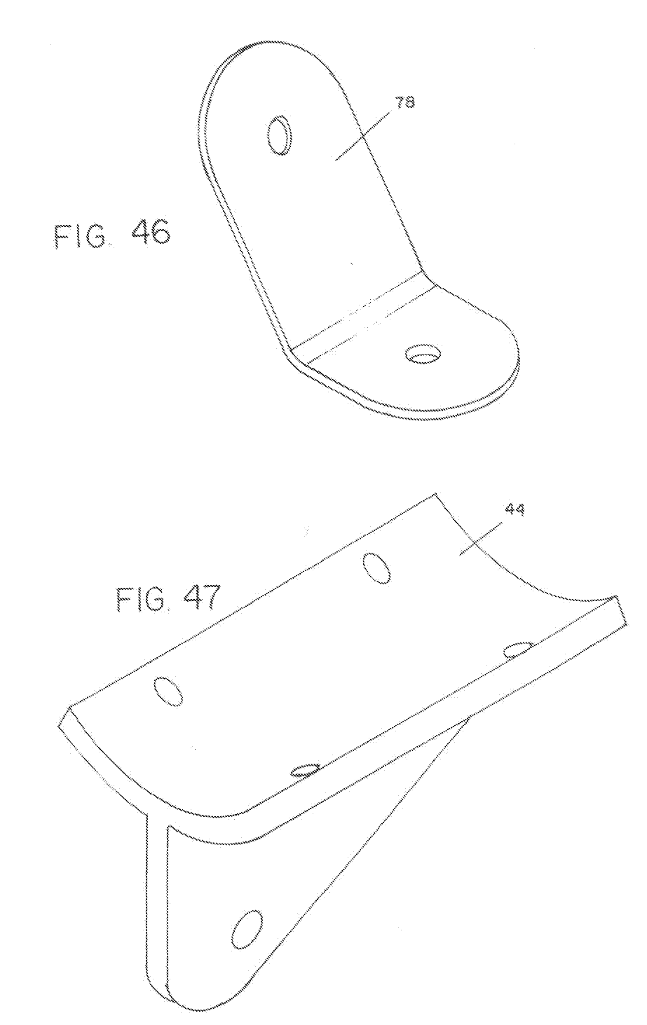

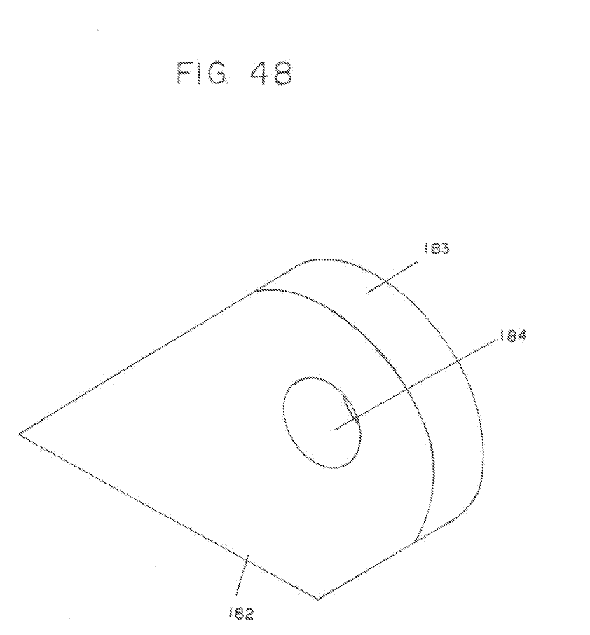

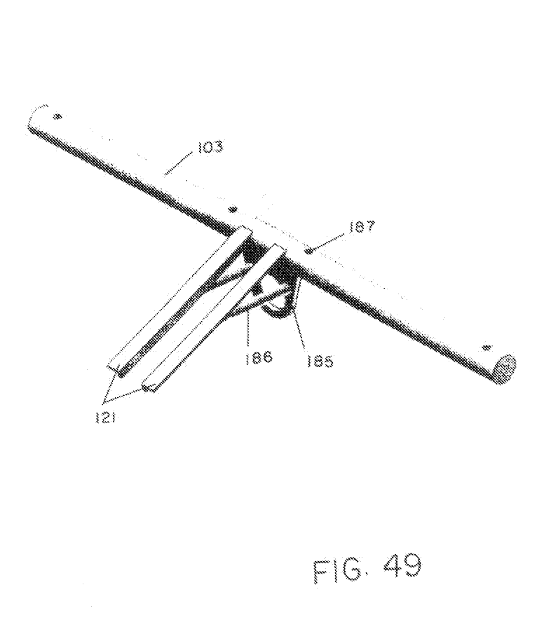

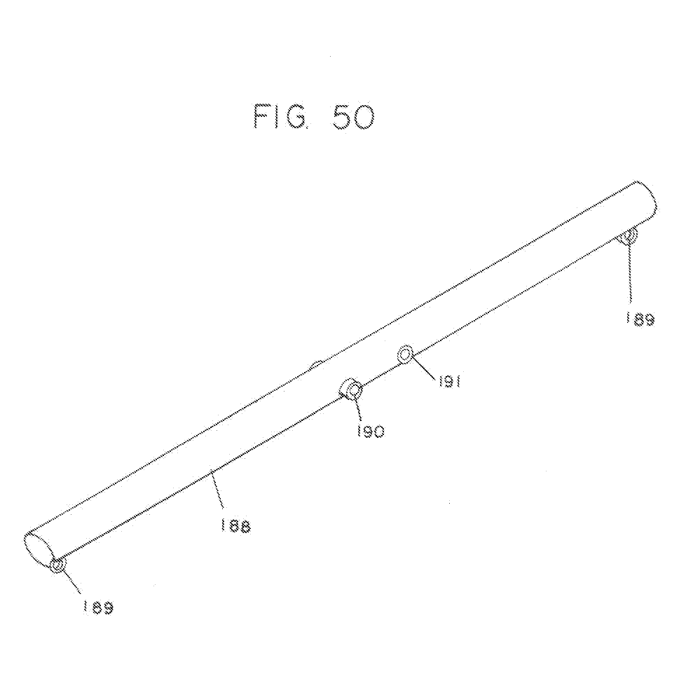

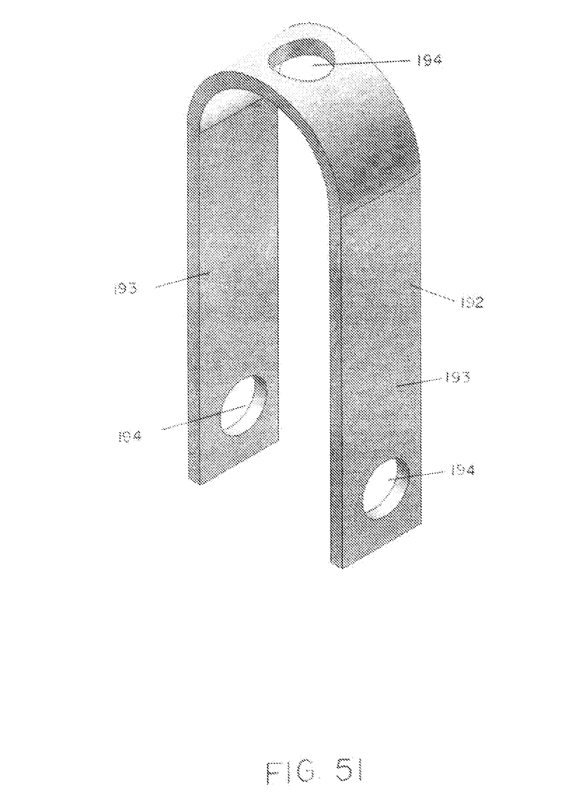

### DETAILED DESCRIPTION OF THE INVENTION

The set of conjugated components to build a ultralight type airplane, subject of this application for invention patent, consists, in more detail, of a set of parts to build a ultralight type airplane, this set of components consisting of fuselage (1); wings (2); empennages (3); landing gear (4); systems (5) which include the controls (6) with joint terminations and fuel system consisting of a metal tank (7) fixed on the same level of the engine, with a vent, cover and system cutting valve; propelling unit (8) formed by an Otto's four cycle engine (9), which uses aviation gasoline, started through CDI, with cutting switch available to the pilot.

The fuselage (1) is formed by tubes (10) preferably made of aeronautical alloy aluminum (type 6061 T6) with some steel reinforcements, preferably made of steel 4130N. The tubes (10) made of aeronautical aluminum alloy are two lower tubes (12) which project from the front region of the airplane up to the back region, and between them there is an angle of 6°; an upper tube (13) projects also from the front part to the back part of the structure, and this upper tube (13) is positioned on a middle longitudinal line between the two lower tubes (12), and on the maximum front end the distal points of these points are defined as 1200 mm; said upper tube (13) has a 6° angle as regards the horizontal axis (H), and this is the same angle formed by the lower tubes (12) with regard to the same horizontal axis (H), the lower tubes (12) are fixed, on the front part, on the transversal steel axis (14) which receives the axes (14a) of the front wheels (15) of the landing gear; while the upper tube (13) goes from the front end, where it connects to the cradle (16) of the propelling unit (8), with the said cradle (16) having a general triangular configuration formed by the welded steel tubes which configure an elevated base to place the above referred propelling unit (8).

Along the fuselage (1) tubes (17) are distributed by pairs, so that each component of a pair is transversally aligned, projecting from the lower tubes (12) up to the upper tube (13) forming actual triangles, while the junction, both with the lower tubes (12) as with the upper one (13) requires the use of special connections or catches (18), and the lower connections (18a) surround partially the contour of the corresponding lower tube (12) and project, above, almost parallel skirts (19) among which is included a flat end (20) of the corresponding tubes (17), for fixation purposes by means of screws AN (17a) where tension adjusting threads (21) are further applied for the steel cables (22) which act as diagonal wires to absorb the shear stresses. The junction of the tubes (17) with the upper tube (13) is made by connections (18b) which totally and circularly wrap up the referred upper tube (13) and project to the slightly inclined side skirts (23) which receive the flat ends (24) opposite to said pipes (17) where, similarly, AN type screws (17a) are applied and which receive also tension-adjusting threads (21). The steel cables (22) exercise the function of wires, as said above, through diagonal displacements on the two sides of the airplane, from the first and up to the last quadrant, with each fixation point provided with a tension-adjusting thread (21) in the form of two blades similar to clamps (21a) where the closed side of each clamp (21a) receives the threaded end (25) for the corresponding steel cable (22).

The fuselage (1) has, further, reinforcement structural elements (26) preferably made of steel, normally distributed among the lower tubes (12).

Said lower tubes (12) have their back ends united by means of a flat plate (27), with two points of fixation by means of screws on each side (28), with said flat plate (27) configurating on its center a bearing (29) which receives a crosspiece (30) which can be pivoted around the vertical axis of this bearing (29), while the section of this crosspiece (30) orthogonal to the axis of the bearing (29) projects a cylindrical element (31) the ends of which are attached to bearings (32) incorporated to the set of the tail (33), providing, in this way, the horizontal articulation of this set of the tail (33), around the axis formed by the cylindrical element (31).

The lower tubes (12) have, on the level formed among them, steel wires (22) similar to the above referred ones, which employ the same tension adjusting threads (21) formed by blades similar to clamps (21a).

The cradle (16) receives, on the bottom and the front, the ends of a pair of tubes (34) the lower ends of which are attached to substantially “U” shaped catches (35) placed on the axis tube of the wheels (14) by means of special screws from where they advance raised and frontwards, so as to attach to the cradle (16), and on the side of said tubes (34) fixed to the axis of the wheels (14), there are two other tubes (36), which raise so as to form a triangle and are fixed on the lower back part of the cradle (16); sidewise to said tubes (34), with the same catches (35) and with the same screws, the flattened ends of the tubes (37) which displace diagonally and are fixed on the upper part, on the inside of said tubes (34), which receive by means of catches (37b), upper and lower pairs of plates (38) which fix the radiator (39) of the propelling unit (8).

Connections (40) are attached to the tubes (36) close to their lower ends, which almost surround said tubes (36) and, from these circular sections, parallel skirts (42) project, among which the ends of the tubes (43) are attached which raise sidewise and slopingly towards the wings (2), where they are attached by means of special catches (44) incorporated on the lower part of the structure of the wing (2)

Furthermore, side catches (45) are attach to the tubes (36) at a level close to the one of the propelling unit (8), and these side catches (45) partially surround those tubes (36) and have parallel skirts (46) among which are fitted the flattened ends of the tubes (47) which raise slopingly from the sides towards the center, ending beside the upper tube (13), and these tubes (47) take an approximately triangular configuration where a fairy is attached (48).

The propelling unit (8) is supported on the cradle (16), which is welded and fixed to the structure by means of rubber pads (11), while on the front part of the upper pipe (13) in the region where it connects to the cradle (16), two sets of special catches (49) are provided, which surround the upper tube (13) and have upper parallel skirts (50) where small supporting pipes (51) are fixed which work as supports for the upper reservoir of said propelling unit (8), while side plates (52), laid by pairs on each fixation point, are intended to provide side support to said upper reservoir.

The wings (2) have a structure formed by two girders (53) made of aeronautical alloy aluminium (type 6061 T6), that is to say, a pair of girders (53) on each side of the wing (2), and these girders (53) are supported by the described tubes (36) which link them to the lower part of the fuselage (1). On the central part, where the girders (53) on the opposite sides of the wing (2) meet, a tube (54) is provided beside the pair of front girders (53), which is incorporated to the front superior part of the cradle (16), with said tube (54) coupled on both ends, with nylon or similar material cylindric bushings (55) inside said girders (53). The pair of back girders (53) receives a tube (56) coupled on said cilindric bushings (55), with this tube (56) incorporated to a small metal square (57) which is coupled to the first set of tubes (17) which project substantially in “V” shape, with the vortex on the upper part, and these tubes (17) extend to the lower tubes (12) where they are attached by means of catches with screws (18), and these catches partially wrap up the tubes (12) and project parallel skirts (19) among which fit the flattened ends of said tubes (17), to which are attached on a preferably upper sector, catches (58) which attach tubes (55) that extend up to the lower tubes (12) where they are attached also by means of catches (60) which partially surround the lower tubes (12) and project skirts (61) among which the ends of the pipes (59) are fixed by means of special screws of the type already mentioned in this report, with this specification being almost a general one. These tubes (59) serve as receiving elements of a transversal tube (62) where by traditional means, the seat (63) of the pilot is fixed.

On the wings (2) sectors at equal distances are provided consisting of ribs (64) preferably made of aluminium, which go from one girder to the next, to build the profile of the airfoil that has particular characteristics, which determine the excellent sustentation of the airplane. These ribs (64) are composed, basically, each of them, of an upper profile (65) substantially “T” shaped which goes over the girder (63) with a thin plate (67) between it and the corresponding lower profile (66), and this plate has a perforation of a diameter which matches that of the girder (63), however, this plate (67) raises little beyond the diameter of the corresponding girder (53), and meets the branches of the “T” profile (65) and (66) on the same level, creating, this way, a support surface where stainless steel or age-hardening aluminum rivets are applied, as it is the case for all points that require said rivets. As the profile (65) and (66) which form one same rib (64) are bended to acquire the profile of the airfoil, the central segment naturally has longer distance between them. For that purpose, the wing (2) has substantially “V” shaped profiles (68) with grooves (69) on the ends, which are fitted to the profiles (65) and (66) and fixed by means of rivets.

Beside the back girders (53) and, more particularly, juxtaposed to them, close to the ends of the wing (2), parallel aluminum profiles (70) are fixed, in particular two profiles adjacent to each other which form surfaces (71) to fix the profile (65) originating from the front part of the wing (2), as well as surfaces (72) which extend from said plates up to the back part of the wing (2).

On each side of the wing (2) there are four upper wires (73) and four lower wires (74), with the upper wires fixed on the end of the compression tube (King post) (75) attached and raised starting from an upper tube (13), while the lower wires (74) are fixed on the left and right side of the wing (2), to a bracing device (80) provided on the non-turning end of the wheel. Theses wires (73) and (74) are steel cables with grommets (76) at the ends which provide points for fixation, while, on the other side, the attachment on the wing (2) requires on the four mentioned points reinforced plastic bushings (77) and theses bushings are fitted in the corresponding openings provided on the girders (53), on axes which are orthogonal among them, so that on the ends of each bushing (77) a catch (78) is inserted forming approximately an “L”, the end of which includes a retention pin (79) for the corresponding wire.

The described sequence of wires (73) and (74) and the tubular support generate a redundant structure which supports the positive and negative load of the wing (2), and support further its torsion stresses. Therefore, the tubular girder (53) is subject to flexion compression stresses. On the other hand, the ribs (34), through the “T” type profiles (65) and (66), linked through several aluminum rivets, generate the shape of the airfoil in the structure of support and compression among the girders (53).

The leading edge (B) of the wing (2) is made by an aeronautical alloy aluminum tube (54) (as all the other aluminum components), which extends from the central region of the airplane, fixed as described, until it is interrupted on each side of the wing (2), beside the third right and left ribs (34), and the chord is defined starting from a bigger dimension immediately after this interrupted segments. The trailing edge (F) is made of aeronautical alloy aluminum plate (81), and the fixation of the ribs (34) is made with rivets.

The wing (2) is coated with fabric (82) preferably of glued polyester, stretched and shrink-wrapped with no ultraviolet (UV) ray protection.

With this construction, a wing (2) is achieved that, compared to the original project has a larger section, and this, besides the possibility of mass production, provides for increased efficiency and quickness, and improved sustentation of the airplane.

The controls or commands (6) include the front axis (14) which receives, on the ends, the axes (14a) of the wheels, with said axes (14) having side supports (85) incorporated with fixation points for the brake device (86) which is a conventional one; for that purpose, more to the center, arms (83) are provided to receive the ends of the axes (84) of the articulated pedals (87) which operate those brakes.

The above mentioned front axe (84) is inserted in tubes (84a) (one on each side) where incorporated skirts (88) are provided, which receive the support (89) of the pedals (90) that operate the tail wheel; for that purpose on the center area of the tubes (84a), between said pedals (90), vertical arms (91) are incorporated, with adjustment orifices (92), in which joints (93) are inserted, connected by means of adjustment threads to parallel rods (94) which extend up to lower transversal tubular axe (95) which is attached as a pivot to an upper parallel fixed axe (96) positioned immediately above and which is fixed on the lower tubes (12) by means of catches (97) which surround such lower tubes (12) and project parallel skirts (98) among which the ends of said fixed axe (96) are fitted and fixed by means of special screws of the type above referred. Said lower transversal axe (95) has incorporated, aligned with the rods (94), flat plates (99) each of them with orifices for adjustment, which receive the joints (93) of said rods (94), while on the opposite side they project tensors (100) for the steel cables (101) which then are guided by two plastic pulleys (102) attached on a fixed transversal arm (103) which is attached by means of special catches (104), to the lower tubes (12) so that these steel cables (101) are guided by pulleys (101B) up to the tail wheel (105), where they have adjustments and are fixed on a small flat plate (106) with adjustment orifices (107), this tail wheel is articulated on its axe with bushing and a fork (108) passing before through guiding pulleys (101C).

The transversal lower axis (95) receives, on the opposite ends, steel cable terminals (109) with adjustment threads, which are intended to operate the rudder, passing along pulleys (110) set on the side at the height of the lower tubes (12), going towards the pulleys from where they are guided to pulleys (112) laid under the lower tubes (12), and from there opening in a large angle for the opposite vortices of the tail (C1), so as to allow to fully operate it on a horizontal level, through the devices described above, and thus performing the function of a rudder.

The joystick (113) is placed in front of the pilot as a lever, which is attached, so as to pivot, to a linear movement axis (114) inserted in the cylindrical tube (115) which can be rotated though the utilization of the arms (96) and (103) as bearings, while the other end of the axis (114) is attached to a fork (116) that, on its free end, has an articulated tubular element (117) around the axis configurated by the pin (118), and said tubular element (117) includes, in a position immediately above, pins (119) with free rotation bushings (120) positioned under substantially “L” shaped plates (121) which project obliquely from the transversal arm (103), to which they are fixed preferably thought welding.

The articulate tubular element (117) receives, on the upper and lower ends, upper and lower steel cables (122), which extend in opposite directions, pass through the corresponding guide pulleys (123) on the upper tube (13) and lower tube (12), and pass before through pulleys (123B), until they reach the maximum upper point (124) and maximum lower point (125) of the tail (C1) to operate it as an elevator, that is to say, it pivots on the vertical axis upon command by the pilot, and to drive the crosspiece (30) as described.

On the same joystick the pilot has the aileron command, which is totally new as regards the original Demoiselle version. For that purpose, above the fixed transversal arm (103), a transversal tube (126) is laid, the ends of which are flat and attached by side catches (127) by means of special screws of the type described, and this transversal tube (126) receives a fixed substantially “L” shaped support plate (128), which has, at its ends, indentures, to attach the vertical movement transmissor (130) for the aileron (131) provided on the wing (2), with this vertical movement transmissor (130) attached, so as to pivot, to a horn (133), with points of adjustment with the shape of orifices (134) and this horn can turn around its axis upon side movement of the joystick to drive the aileron (131); this command is made from the vertical transmissor (130) which answers vertically to the turning of the horn (133). The upper end of the vertical transmissor (130) projects vertically a mechanical transmission harness, such as a steel cable (135) which extends inside the wing structure (2) until it attaches on the mechanical cylinder (136) which can in its turn pivot, by means of a kind of fork (137), to the support of a substantially “L” shaped aluminum plate (138), riveted on the structural part on the inside of said aileron (131).

The empennages (3) include the so called tail set (33) built completely with the aeronautical alloy aluminum (type 6061 T6) tubes with reduced diameter (132) interconnected by means of riveted aluminum plates (139); with this empennages (3) coated with glued shrink-wrapped and sealed polyester that, as in the case of the wings (2), has no UV protection.

The empennages (3) are, as described above, fully mobile and rigidly linked by means of steel cables; still, as already reported, they have horizontal and vertical pivoting on steel and aluminum bearings. Because of the possible aerodynamical excitation of the wing (2) on the empennage (3), all the set is 100% balanced on the horizontal and vertical axis.

Besides the components listed and described above, we stress as important elements of the invention the connection set (141) of the tail, substantially in the form of an elongated tube with end “V” shaped inverted derivations (142) and an intermediate orthogonal derivation (143).

The catches mentioned along the text, in their basic constructions are: catch (P1) of the perforated cylinder core (144), skirts (145) in an axis orthogonal to that of the cylinder core (144), limited by a diameter smaller than that of said core (144), besides the orifices (146) aligned on both axis; catch (P2) that has a cylinder core (147) with side skirts (148) that project in an angle, the skirts with aligned orifices (149); catch (P3) with a cylinder core (150), parallel skirts (151) and continuing as regards the diameter of said core (150), with aligned orifices (152); catch (P4) with cylinder core (153) and one single side skirt (154) with an orifice (155).

The axis of the front wheel (14a) is provided with a cylinder section of longer extension (156), reduced and shorter length diameter sector (157), followed by another sector with a shorter diameter (158), from which an almost intermediate extension (159) projects, which have a quite reduced diameter, followed by another cylinder sector (160) with a diameter similar to that of sector (158), ending with a threaded end (161).

Although the tubular parts are not specified because they are different just as regards the dimensions, we make a special mention to the wing tube (162).

The break (163) is also a specially designed device, which has a handle (164) and an almost semicircular end (165), an extension (166) and a perforated cylinder end (167), besides the approximately intermediate perforated cylinder insertion (168) on the side of the extension opposite to its end (167).

The pulley (169) is made of nylon or any similar material and is to be used together with the axis (170) on the engine supporting set. The catch (171) is to be used also for the engine support, and is substantially “U” shaped with on aligned orifices (172).

The invention includes further a substantially rectangular metal plate (173) with skirts (174) projected slopingly outwards on the longer sides of the rectangles and each of them with four orifices (175), while, on the shorter sides of the rectangle, two smaller skirts are inclined outwards (176) each of them with one single orifice (177).

The part (178) is the base of the spindle that holds the wing (2), and is formed by a cylinder sector (179) and a cylinder sector which is chamfered on diametrically opposed segments (180) with a threaded orifice (181).

The part (182) is a substantially triangular skirt, to fix the vertical tale, with its end opposite to the rounded vortex (183) and an orifice (184).

The so called second set is formed by the components (103), (121) besides a plate with an orifice (185) on the component (103), for the tube (115), and reinforcements (186) and orifices (187) on the axis (103), are also shown.

The second set lever (188) is a cylinder axis with threaded end seats (189) projected beyond the diameter dimensions of the axis, besides approximately intermediate and cylinder seats (190) projected outwards on diametrical opposed points of said axis, and in a position that is approximately symmetrical to the central axis and axially to the axis, there is an orifice (191). The second set shows, further, a catch (192) to fix it, which is substantially an inverted “U”, with elongated straight segments (193) and provided with orifices (194), one of them on the rounded part between the straight segments and the others on the ends of said straight segments (193).

The propeller (140) is of the two blade type (traction system), while the airplane obtained, according to the described components has, as a function of prior specifications as well as a function of field tests that were performed, the following technical and performance characteristics:

| Dimensions | | |
|---|---|---|
| Aerodynamical medium chord | 1.90 | m |
| Length | 6.70 | m |
| Height | 2.30 | m |
| Span | 7.50 | m |
| Landing gear gage | 1.12 | m |
| Weights | | |
| Empty weight | 145 | kg |
| Maximum takeoff weight | 270 | kg |
| Pilot weight (RBHA) | 86 | kg |
| Surface deflections | | |
| Flaps | none | |
| Ailerons | Ø20°/15°Ø | |
| Elevators | Ø15°/12°Ø | |
| Rudder | Ø15°/15°Ø | |
| Trimmer | none | |
| Gravity Center Coordinates | | |
| Front limit | 22% cma | |
| Back limit | 27% cma | |
| Performance | | |
| Cruise speed | 90 | km/h |
| Stall speed | 52 | km/h |
| Maneuvering speed | 70 | km/h |
| Never to exceed speed | 110 | km/h |
| Take off distance | 200 | m |
| Landing distance | 155 | m |
| Ascension speed | 50 | fpm |
| Operation ceiling | 2000 | m |
| Engine | | |
| Make | HKS | |
| Model | 700E | |
| Power | 65 | HP |
| Cylinders | 4 (four) | |
| Reduction | 3.47:1 | |
| Propeller | | |
| Manufacture | Orlei | |
| Type | wooden | |
| Diameter | 70″ | |
| Pitch | fixed | |
| Number of blades | 2 (two) | |
| Fuel | | |
| Tank capacity | 20 | liters |

| | |
|---|---|
| Type | Avgas or Podium |

1. A set of conjugated components to build a ultralight type airplane consisting of a set of parts for the composition of a ultralight type airplane similar to the handmade Demoiselle model, with this set of components including the fuselage; wings; empennages; landing gear; systems which include the control; with articulated ends and fuel system consisting of a metal tank fixed at the same level of the engine, with a vent, cover and system cutting valve; propelling unit formed by an Otto's four-cycle engine, driven with aviation gasoline, started through CDI with a cutting switch accessible to the pilot; characterized by using basically, as raw material, aeronautical alloy aluminum and specific steel, with the fuselage formed by tubes preferably made of aeronautical alloy aluminum with some steel reinforcements, preferably of steel 4130N; the tubes are two lower tubes, which project from the front region of the airplane up to the back region, having between them a 6° angle, a superior tube with compatible length, projecting also from the front part to the back of the structure, with this superior tube positioned on an average longitudinal line between the two lower tubes, while on the front maximum end, the distal points of these tube are defined with 1200 mm; as regards the layout the components, and as a significant constructive element it is established, that said upper tube forms a 6° angle of inclination with the horizontal axis, this being the same angle formed by the lower tubes as regards the same horizontal axis.

2. The set of conjugated components to build a ultralight type airplane according to claim 1, wherein the lower tubes are fixed, on the front part, on the transversal steel axis which receives the axes of the landing gear front wheels; while the upper tube extends from the front end, where it connects to the cradle of the propelling unit, which said cradle having an approximately triangular general configuration based on steel welded tubes that form the elevated base to put the above referred propelling unit.

3. The set of conjugated components to build a ultralight type airplane according to claim 1, wherein along the fuselage tubes are distributed, disposed by pairs, so that each component of one pair is transversally aligned projecting from the lower tubes up to the upper tube forming real triangles, while the junction of both lower tubes as the upper tubes requires the use of connections or special catches, with the lower connections partially surrounding the contour of the corresponding lower tube and projecting, on the upper part, almost parallel skirts between which is inserted the flat end of the corresponding tubes, to be fixed by means of screws AN where further tension adjusting threads are applied for the steel cables, the junction of the tubes with the upper tubes is made by means of connections which circularly and totally surround the abovementioned upper tube and projects to the slightly inclined side skirts which receive the opposite flat ends of said tubes where, similarly, screws of the type AN are applied and which receive also tension adjusting threads; the tension adjusting thread has the shape of blades similar to clamps and the closed side of each of those clamps receives a threaded end for the corresponding steel cable; the fuselage has further reinforcement structural elements, preferably made of steel, and distributed normally among the lower tubes.

4. The set of conjugated components to build a ultralight type airplane according to claim 1, wherein said lower tubes have their back ends united by means of a flat plate, with two points of fixation by screws on each side, with said flat plate centrally configurating a bearing which receives a crosspiece that can be pivoted around the vertical axis of this bearing, while the section of this crosspiece orthogonal to the bearing axis projects a cylinder element the ends of which are attached to bearings incorporated to the tail set.

5. The set of conjugated components to build a ultralight type airplane according to claim 1, wherein the cradle receives, on the lower and front part, the ends of a pair of tubes the lower ends of which are attached on substantially “U” shaped catches laid on the axis of the wheels by means of special screws where they advance raised in the front direction so as to attach to the cradle; and on the side of said tubes and fixed to the axis of the wheels, there are two other tubes which raise so as to form a triangle and are fixed on the lower back part of the cradle; on the sides of the above mentioned tubes, the flattened ends of the tubes are attached on the same catches and with the same screws, and said flattened ends move diagonally and are fixed on the top part of the internal side of said tubes, which receive upper and lower pairs of plates which fix the radiator of the propelling unit.

6. The set of conjugated components to build a ultralight type airplane according to claim 1, wherein the tubes are attached at a level close to that of the propelling unit, with side catches that partially surround these tubes with theses catches configuring parallel skirts, between which the flattened ends of the tubes are fit, which raise slopingly from the sides towards the center, ending beside the upper tube and these tubes take an approximately triangular configuration where a fairing is attached.

7. The set of conjugated components to build a ultralight type airplane according to claim 1, wherein the propelling unit is supported on the cradle, which is welded and attached to the structure by means of rubber pads, while, on the front part of the upper tube, on the region where it connects the cradle, two sets of special catches are provided which surround the upper tube and configure the parallel upper skirts on which small tubes are fitted which support the upper reservoir of said propelling unit, while on the sides there are side plates, laid two by two on each fixation point.

8. The set of conjugated components to build a ultralight type airplane according to claim 1, wherein the wings sectors are laid at equal distances, consisting of ribs preferably of aluminum, which extend from a girder to the next to build the profile of the airfoil; these ribs are made, basically, each, by an upper profile, substantially “T” shaped, which goes over the girders, and between it and the corresponding lower profile there is a thin plate, which has a perforation with a diameter compatible with that of the girder, however this plate raises little beyond the diameter of the corresponding girder, meeting the branches of the “T” of the profiles and which are placed at one same level, creating in this way a supporting surface where stainless steel or age-hardening aluminum rivets are applied; as the profiles and which form one same rib are bended in order to have the profile of the airfoil, the central segment has naturally a greater distance between them; for that purpose, the wing provides substantially “V” shaped profiles with grooves on the ends, which are fitted into the profile and fixed by means of rivets.

9. The set of conjugated components to build a ultralight type airplane according to claims 1, wherein beside the back girders, and specifically juxtaposed to them in a layout close to the ends of the wings, parallel aluminum profiles are fixed, in particular, two profiles contiguous between them which form surfaces to fix the profiles and coming from the front part of the wings, as well as surfaces that extend from said plates up to the back part of the wing.

10. The set of conjugated components to build a ultralight type airplane according to claim 1, wherein on each side of the wing there are four upper wires and four lower wires, with the upper wires fixed on the end of a compression tube (“King post”) attached and raised starting from and upper tube, while the lower wires are fixed on the left and right sides of the wing, to a braising device provided on the non-rolling end of the wheel set; the wires and are steel cables with grommets at the end which ensure the fixation points and on the other hand the fixation on the wing requires the use, in the four mentioned points, of bushings made of reinforced plastic, with these bushings fixed in the corresponding openings provided on the girders, in axes which are orthogonal among them, so that, on the ends of each of these bushings, a catch is inserted forming approximately an “L”, the end of which includes a retention pin for the corresponding wire.

11. The set of conjugated components to build a ultralight type airplane according to claim 1, wherein the sequence of wires and and the tubular support produce a redundant structure which supports the positive and negative load of the wing, besides supporting the torsion stresses of the wing; the ribs, through a series of “T” shaped profiles and, linked by means of multiple aluminum rivets, generate the shape of the airfoil and the supporting and compression structure among the girders.

12. The set of conjugated components to build a ultralight type airplane according to claim 1, wherein the leading edge of the wing is made by an aeronautical alloy aluminum tube which extends from the central region of the airplane until it is interrupted on each side of the wing beside the third right and left ribs, with the chord defined starting from a larger dimension immediately after these interrupted segments.

13. The set of conjugated components to build a ultralight type airplane according to claim 1, wherein the trailing edge is made with aeronautical alloy aluminum plate, and the fixation of the ribs is made by means of rivets; the wing is coated with a fabric preferably made of glued shrink-wrapped polyester with no protection against ultraviolet (UV) rays.

14. The set of conjugated components to build a ultralight type airplane according to claim 1, wherein the plane controls or commands include the front axis, which receives, on its ends, the axes of the wheels, with the said axis having incorporated side supports with fixation points for the braking device; for that purpose, more to the centre, arms are provided to receive the ends of the axis of the articulated pedals which operate the above referred breaks.

15. The set of conjugated components to build a ultralight type airplane according to claim 1, wherein the above referred front axis (is inserted into tubes (one on each side) where incorporated skirts are provided, which receive the supports of the pedals to operate the tail wheel; for that purpose, on the central region of the tubes, between said pedals, vertical arms are incorporated with adjustments orifices, on which junctions are fit, by means of adjustment threads, on parallel rods which extend up to a lower tubular axis which is attached, so as to pivot, to an upper parallel fixed axis positioned immediately above, and which is fixed on the lower tubes by means of catches, which surround said lower tubes and project parallel skirts among which the ends of said fixed axis are inserted and fixed by means of screws; said lower transversal axis has incorporated and aligned with the rods, flat plates each with adjustment orifices, that receive the junctions of said rods, while on the opposite side they project stretching devices for the steel cables which, immediately, are guided by means of two plastic pulleys attached on a fixed transversal arm which in its turn is attached, by means of special catches, to the lower tubes, so that these steel cables are guided, by means of pulleys up to the tail wheel, where they have adjustments and are fixed on a small flat plate with adjustment orifices, with this tail wheel articulated on an axis with a bushing and a fork.

16. The set of conjugated components to build a ultralight type airplane according to claims 1, wherein the transversal lower axis receives on the opposite ends steel cable terminals with adjustment threads, which drive the rudder, going through pulleys placed on the sides, at the height of the lower tubes following from there to pulleys from where they are guided towards pulleys placed under the lower tubes and, from there, opening a great angle for the opposite tail vortices.

17. The set of conjugated components to build a ultralight type airplane according to claim 1, wherein the joystick is placed in front of the pilot, as a lever, which is attached so as to pivot to a linear displacement axis inserted inside a cylinder tube which can be turned by using the arms and as bearings, while the other end of the axis is attached to a fork which, on its free end, has an articulable tubular element around an axis configurated by a pin, and said tubular element incorporates, in a position immediately above, pins with free turning bushings positioned on the substantially “L” shaped plates which project obliquely from the transversal arm, to which they are fixed preferably by means of welding.

18. The set of conjugated components to build a ultralight type airplane according to claim 1, wherein the articulable tubular element receives, on the upper and lower ends, upper and lower steel cables, which extend in opposite directions, go to the corresponding guiding pulleys until they reach the upper maximum point and lower maximum point of the tail to operate it as an elevator, that is to say, it pivots on the vertical axis according to the command of the pilot and the action of the crosspiece.

19. The set of conjugated components to build a ultralight type airplane according to claim 1, consisting of being a ultralight type airplane of the Demoiselle sort, in which the joystick controls the aileron; above the fixed transversal arm a transversal tube is laid, the ends of which are flat and attached to side catches by means of screws, and the transversal tube receives a fixed, substantially “L” shaped support plate, which has, at its ends, indentures to attach the vertical transmission to operate the aileron of the wing, with this vertical transmitter attached, pivotally, to a horn with adjustment points in the form of orifices, with this horn capable of turning around its axis, upon side movement of the joystick, to drive the aileron; this command is achieved with the vertical transmitter that answers vertically to the rotation of the horn; the upper end of the vertical transmitter projects vertically a mechanical transmission harness as a steel cable which extends inwards the structure of the wing until this attaches on the mechanical cylinder, which in its turn can pivot by means of a kind of fork, to the support made of an aluminum substantially “L” shaped plate, which is riveted on the structural part on the inside of said aileron.

20. The set of conjugated components to build a ultralight type airplane according to claim 1, wherein the upper end of the vertical transmitter projects vertically a mechanical transmission harness as a steel cable which extends inside the wing structure until it attaches to the mechanical cylinder which, in its turn, can pivot, by means of a kind of fork, on this support of an aluminum substantially “L” shaped plate, which is riveted on the structural part of the inside of said aileron.

21. The set of conjugated components to build a ultralight type airplane according to claim 1, wherein the empennages include the so-called tail set all of it built with aeronautical alloy aluminum tubes with reduced diameter interconnected by means of riveted aluminum plates; with these empennages coated with glued, shrink-wrapped and sealed polyester, while, as in the case of the wings, they have no UV rays protection; the empennages include horizontal and vertical entirely mobile parts which are rigidly connected to the fuselage by means of steel cables; further, as reported, it has a horizontal and vertical pivot action on steel and aluminum bearings; and, because of the possible aerodynamical excitation of the wing on the empennage, all the set is 100% balanced on the vertical and horizontal axes.

22. The set of conjugated components to build a ultralight type airplane according to claim 1, wherein the connection set of the tail consists substantially of an elongated tube and “V” shaped inverted derivations and an intermediate orthogonal derivation.

23. The set of conjugated components to build a ultralight type airplane according to claim 1, wherein it has catches with the following basic structure: catch with a perforated cylinder core, skirts on an axis which is orthogonal to that of the cylinder core, limited by a smaller diameter than that of the core besides the orifices aligned on both sides of the axes; the catch has a cylinder core with side skirts projected in an angle, these skirts with aligned orifices; the catch with cylinder core, parallel skirts continued as regards the diameter of said core, with aligned orifices (152); the catch with a cylinder core and a single side skirt with an orifice.

24. The set of conjugated components to build a ultralight type airplane according to claim 1, wherein the axis of the front wheel is provided with a longer extension cylinder sector, a reduced and short extension diameter and shorter sector, followed by another sector with a shorter diameter, from which projects an almost intermediate extension with a quite reduced diameter, followed by another cylinder sector with a diameter similar to the sector, ending with a threaded end.

25. The set of conjugated components to build a ultralight type airplane according to claim 1, further having a brake with a handle which has an almost semicircular end, and an extension and a perforated cylinder end, besides an almost intermediate perforated cylinder insertion on the side of the extension opposite to the end.

26. The set of conjugated components to build a ultralight type airplane, according to claim 1, further having a pulley made of nylon or similar material, to be used together with the axis in the engine supporting set; catch substantially “U” shaped with aligned orifices.

27. The set of conjugated components to build a ultralight type airplane, according to claim 1, further having a metallic plate which is substantially rectangular, with skirts inclined outwards on the longer sides of the rectangles and each with four orifices and, on the shorter sides of the rectangle, two smaller skirts inclined outwards each with one single orifice.

28. The set of conjugated components to build a ultralight type airplane according to claim 1, wherein the part is the base of the spindle that holds the wing, consisting of a cylinder sector and a chamfered cylinder sector in diametrically opposed segments with a treaded orifice.

29. The set of conjugated components to build a ultralight type airplane according to claim 1, further having a part in the form of a substantially triangular skirt, for fixation on the vertical tail, with a rounded end opposite to the vertex and an orifice.

30. The set of conjugated components to build a ultralight type airplane according to claim 1, wherein the so-called second set is made by components, besides a plate with an orifice on the component, for the tube, having, further, reinforcements and orifices on the axis.

31. The set of conjugated components to build a ultralight type airplane according to claim 1, wherein the lever of the second set is a cylinder axis with end threaded seats projected beyond the diametric dimensions of the axis, besides approximately intermediate seats and cylinder ones, projected outwards on diametrically opposed points of said axis with an orifice in a position approximately symmetrical to the axis central axis.

32. The set of conjugated components to build a ultralight type airplane according to claim 1, wherein the second set has, further, a catch to fix it, which substantially has the shape of an inverted “U”, with straight-line elongated segments and with orifices, one on the rounding of the straight-line segment and the others on the ends of said straight-line segments.
